(19) United States
(12) Patent Application Publication
(10) Pub. No.: US 2025/0310021 A1
(43) Pub. Date: Oct. 2, 2025

(54) MODULATION SCHEME FOR CHANNEL CODES

(71) Applicant: QUALCOMM Incorporated, San Diego, CA (US)

(72) Inventors: Wei YANG, San Diego, CA (US); Akash Sandeep DOSHI, San Diego, CA (US); June NAMGOONG, San Diego, CA (US); Pinar SEN, San Diego, CA (US); Kirill IVANOV, La Jolla, CA (US); Jing JIANG, San Diego, CA (US)

(21) Appl. No.: 18/617,961

(22) Filed: Mar. 27, 2024

(51) Int. Cl. H04L 1/00; H04L 27/34

(52) U.S. Cl. CPC H04L 1/0003; H04L 27/3405

(57) ABSTRACT

Various aspects generally relate to a channel code modulation scheme that balance protections on different components of a channel code such that no single component dominates overall performance. For example, a transmitter may map two or more bits associated with a channel code to a point in a constellation that is biased toward an asymmetric shape (for example, with non-uniform distances between adjacent points). For example, a pair of bits associated with a channel code may be mapped to a four-point constellation, with each point having an arbitrary position in a coordinate space. In some aspects, the constellation may be asymmetric with respect to both axes of the coordinate space, or the constellation may be asymmetric with respect to one axis and symmetric with respect to the other axis of the coordinate space (for example, associated with a trapezoidal or triangular shape).

### FIELD OF THE DISCLOSURE

Aspects of the present disclosure generally relate to wireless communication and specifically relate to techniques, apparatuses, and methods associated with a modulation scheme for channel codes.

### BACKGROUND

Wireless communication systems are widely deployed to provide various services that may include carrying voice, text, messaging, video, data, and/or other traffic. The services may include unicast, multicast, and/or broadcast services, among other examples. Typical wireless communication systems may employ multiple-access radio access technologies (RATs) capable of supporting communication with multiple users by sharing available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

The above multiple-access RATs have been adopted in various telecommunication standards to provide common protocols that enable different wireless communication devices to communicate on a municipal, national, regional, or global level. An example telecommunication standard is New Radio (NR). NR, which may also be referred to as 5G, is part of a continuous mobile broadband evolution promulgated by the Third Generation Partnership Project (3GPP). NR (and other mobile broadband evolutions beyond NR) may be designed to better support Internet of things (IoT) and reduced capability device deployments, industrial connectivity, millimeter wave (mmWave) expansion, licensed and unlicensed spectrum access, non-terrestrial network (NTN) deployment, sidelink and other device-to-device direct communication technologies (for example, cellular vehicle-to-everything (CV2X) communication), massive multiple-input multiple-output (MIMO), disaggregated network architectures and network topology expansions, multiple-subscriber implementations, high-precision positioning, and/or radio frequency (RF) sensing, among other examples. As the demand for mobile broadband access continues to increase, further improvements in NR may be implemented, and other radio access technologies such as 6G may be introduced, to further advance mobile broadband evolution.

In a wireless communication system, information is generally represented as a sequence of binary bits that are mapped (for example, modulated) to an analog signal waveform that is then transmitted to a receiver over a wireless communication channel. In some cases, however, the wireless communication channel may introduce errors that may corrupt the transmitted signal due to random noise, interference, device impairments, and/or other factors. At the receiver, the received signal (that may have been corrupted during transmission) is mapped back to binary bits, with the received binary information estimating the transmitted binary information. Accordingly, because errors may corrupt the signal that is estimated at the receiver, channel coding or forward error correction (FEC) techniques are often used to control errors in data transmission over unreliable or noisy communication channels or otherwise mitigate the bit errors that may occur due to noise, interference, and/or other factors. For example, channel coding generally includes an encoding operation performed at a transmitter (for example, a first wireless device, which may be a user equipment (UE) or a network node) and a decoding operation performed at a receiver (for example, a second wireless device, which may be a UE or a network node). Channel coding is generally accomplished by selectively introducing redundancy into the transmitted information stream, typically using an error correction code (ECC), which allows the receiver to detect errors and/or correct bit errors in the received data stream and thereby provide more reliable information transmission. Accordingly, channel codes are often used in scenarios where retransmissions are undesirable and/or high transmission reliability is needed, such as downlink and/or uplink control channel communications.

As described herein, some channel codes may be generated or encoded using a Plotkin construction technique, where one or more Plotkin kernels concatenate or combine codes in such a way that a resulting code (for example, a Reed-Muller code and/or a polar code) inherits certain properties from the constituent components. For example, Reed-Muller codes are often used when a message has a small payload size (for example, for an uplink control channel when a payload size is less than or equal to a threshold), and polar codes are often used for messages with a larger payload size (for example, for both uplink and downlink control channels when a payload size exceeds the threshold). The Plotkin construction used to generate Reed-Muller codes, polar codes, and/or other suitable channel codes is a transform function, where a pair of input bits, (u, v), are mapped to two output bits, (u, u+v), where the first output bit is a copy of the first input bit and the second output bit combines the first input bit and the second input bit (for example, according to an exclusive-or (XOR) operation). In this way, the Plotkin construction (for example, a repeat operation and an XOR combination operation) can be performed recursively or iteratively to obtain a channel code with a relatively large error correcting capability.

In a wireless communication scenario in a relatively low to medium signal-to-noise ratio (SNR) range, Reed-Muller codes, polar codes, and/or other channel codes are often used with a phase-shift keying (PSK) modulation technique, such as binary PSK (BPSK) and/or quadrature PSK (QPSK). More particularly, BPSK/QPSK modulation is typically a square modulation, where two bits are mapped to a complex modulation symbol that corresponds to a single point in a four-point constellation that forms a square (for example, in a coordinate space that includes a horizontal axis to represent an in-phase or real component of the complex modulation symbol and a vertical axis to represent a quadrature or imaginary component of the complex modulation symbol). For example, given two bits, (u, v), to be modulated or mapped to a complex modulation symbol, BPSK/QPSK modulation may use a Plotkin construction to map the two bits to a point in the square constellation as follows:

(u,v) [symbol] [(−1)^{u},(−1)^{u+v}],

where (−1)^{u} is an x-coordinate of the complex modulation symbol (for example, positive 1 when u=0 or negative 1 when u=1) and (−1)^{u+v} is a y-coordinate of the complex modulation symbol (for example, positive 1 when u and v are both equal to 0 or both equal to 1, or negative 1 when either u or v, but not both, are equal to 1).

Although BPSK and QPSK modulation schemes exhibit good performance with respect to bit-interleaved coded modulation (BICM) capacity, BPSK/QPSK suffer from drawbacks in cases of channel codes such as Reed-Muller codes or polar codes that typically have a small block length or a code word with a small size. Furthermore, in many cases, a receiver may use a sub-optimal decoder due to practical complexity limitations. For example, the optimal performance associated with BPSK/QPSK modulation in terms of BICM capacity requires infinite block lengths and a machine learning (ML) decoder, which is exponentially more complex than is typically suitable in practical scenarios. Accordingly, in practice, Reed-Muller codes, polar codes, and other channel codes with similar properties (for example, associated with a Plotkin construction) are often decoded using successive cancellation (list) (SC (L)) decoding, which is associated with a decoding performance that generally depends on a weakest point in a decoding chain. For example, in successive cancellation decoding, a decoder first decodes one piece of information and then uses that piece of information to decode a next piece of information, and so on, in a sequential manner. Accordingly, in cases where there is one error in the sequential decoding procedure, decoding will fail for the entire code block. In a square quadrature amplitude modulation (QAM) scheme, such as BPSK/QPSK, the four-point constellation design with a uniform distance between adjacent points creates an imbalance between some branches. For example, in a channel code associated with a Plotkin construction, where (u, v) [symbol] (u, u+v), a successive cancellation decoder first decodes v, and then decodes u conditioned on v (for example, u can be decoded when v is known). In other words, BPSK/QPSK modulation and/or other modulation schemes that use square or other fully symmetric constellation shapes create an imbalance between the u component and the v component of a channel code associated with a Plotkin construction, where decoding performance for the v component dominates the overall decoding performance.

### SUMMARY

Some aspects described herein relate to a transmitter for wireless communication. The transmitter may include a processing system that includes one or more processors and one or more memories coupled with the one or more processors. The processing system may be configured to cause the transmitter to map a pair of bits associated with a channel code to a modulation symbol that corresponds to a point in a constellation that includes a plurality of points, there being non-uniform distances between adjacent points of the plurality of points. The processing system may be configured to cause the transmitter to transmit a signal that conveys the modulation symbol to a receiver.

Some aspects described herein relate to a method of wireless communication performed by a transmitter. The method may include mapping a pair of bits associated with a channel code to a modulation symbol that corresponds to a point in a constellation that includes a plurality of points, there being non-uniform distances between adjacent points of the plurality of points. The method may include transmitting a signal that conveys the modulation symbol to a receiver.

Some aspects described herein relate to a non-transitory computer-readable medium that stores a set of instructions for wireless communication by a transmitter. The set of instructions, when executed by one or more processors of the transmitter, may cause the transmitter to map a pair of bits associated with a channel code to a modulation symbol that corresponds to a point in a constellation that includes a plurality of points, there being non-uniform distances between adjacent points of the plurality of points. The set of instructions, when executed by one or more processors of the transmitter, may cause the transmitter to transmit a signal that conveys the modulation symbol to a receiver.

Some aspects described herein relate to an apparatus for wireless communication. The apparatus may include means for mapping a pair of bits associated with a channel code to a modulation symbol that corresponds to a point in a constellation that includes a plurality of points, there being non-uniform distances between adjacent points of the plurality of points. The apparatus may include means for transmitting a signal that conveys the modulation symbol to a receiver.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, the specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure, but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless network in accordance with the present disclosure.

FIG. 2 is a diagram illustrating an example network node in communication with a user equipment (UE) in a wireless network in accordance with the present disclosure.

FIG. 3 is a diagram illustrating an example disaggregated base station architecture in accordance with the present disclosure.

FIG. 4 is a diagram illustrating an example of a transmit chain and a receive chain in accordance with the present disclosure.

FIG. 5 is a diagram illustrating examples of channel codes in accordance with the present disclosure.

FIG. 6 is a diagram illustrating an example of mapping a channel code to a constellation with equally spaced points in accordance with the present disclosure.

FIGS. 7A-7C are diagrams illustrating examples associated with a modulation scheme for channel codes in accordance with the present disclosure.

FIG. 8 is a flowchart illustrating an example process performed, for example, by a transmitter in accordance with the present disclosure.

FIG. 9 is a diagram of an example apparatus for wireless communication in accordance with the present disclosure.

### DETAILED DESCRIPTION

Various aspects of the present disclosure are described hereinafter with reference to the accompanying drawings. However, aspects of the present disclosure may be embodied in many different forms and is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

Various aspects relate generally to a modulation scheme for channel codes that may balance protections on different components of a channel code such that no single component of the channel code dominates overall performance. Some aspects more specifically relate to a modulation scheme that may map a channel code that includes two or more bits to a point in a constellation that is biased toward an asymmetric shape. In some aspects, the constellation includes multiple points in a coordinate space that includes a first (for example, horizontal) axis to represent an in-phase or real component of a complex modulation symbol and a second (for example, vertical) axis to represent a quadrature or imaginary component of the complex modulation symbol, there being non-uniform distances between adjacent points in the constellation. For example, to modulate a pair of bits associated with a channel code, such as a Reed-Muller code or a polar code, the constellation may have exactly four points (each representing a possible combination of values for the pair bits), where each point may have an arbitrary position in the coordinate space. Furthermore, to avoid over-clustering the points in the constellation and thereby improve decoding performance, each quadrant may have an equal quantity of points (for example, one point per quadrant for a four-point constellation associated with a two-bit mapping and/or one point per quadrant and one point on each segment of an axis that separates two quadrants for an eight-point constellation associated with a three-bit mapping, among other examples). In some aspects, the constellation may have a shape that is asymmetric with respect to both axes of the coordinate space, or the constellation may have a shape (for example, a trapezoidal or triangular shape) that is asymmetric with respect to one axis of the coordinate space and symmetric with respect to the other axis of the coordinate space.

Particular aspects of the subject matter described in this disclosure can be implemented to realize one or more of the following potential advantages. In some examples, the described techniques can be used to map two or more bits associated with a channel code to a complex modulation symbol in a manner that balances protections on each bit such that no single bit dominates overall modulation performance. Accordingly, in some examples, the described techniques can improve modulation and decoding performance for a channel code when a receiver uses a sub-optimal decoder, such as a successive cancellation (list) decoder, which may reduce complexity and/or conserve resources at the receiver relative to an ideal or optimal decoder (for example, a machine learning (ML) decoder). For example, the described techniques may be used to design a constellation with an asymmetric or partially asymmetric shape such that, when a signal is uniformly distributed over the points forming the constellation, a resulting modulated symbol has a zero mean and a unit variance. In addition, the described techniques can be used to optimize one or more parameters that define the constellation shape according to a coding rate and/or the decoder in use at the receiver, which may improve performance in accordance with specific channel conditions (for example, a lower bit error rate (BER), a lower block error rate (BLER), a distance spectrum with a more Gaussian distribution, and/or a higher signal-to-noise (SNR) relative to binary phase-shift keying (BPSK) and/or quadrature phase-shift keying (QPSK) modulation techniques that map channel codes to constellations with a symmetric shape, such as a square or a circle).

Multiple-access radio access technologies (RATs) have been adopted in various telecommunication standards to provide common protocols that enable wireless communication devices to communicate on a municipal, enterprise, national, regional, or global level. For example, 5G New Radio (NR) is part of a continuous mobile broadband evolution promulgated by the Third Generation Partnership Project (3GPP). 5G NR supports various technologies and use cases including enhanced mobile broadband (cMBB), ultra-reliable low-latency communication (URLLC), massive machine-type communication (mMTC), millimeter wave (mmWave) technology, beamforming, network slicing, edge computing, Internet of Things (IoT) connectivity and management, and network function virtualization (NFV).

As the demand for broadband access increases and as technologies supported by wireless communication networks evolve, further technological improvements may be adopted in or implemented for 5G NR or future RATs, such as 6G, to further advance the evolution of wireless communication for a wide variety of existing and new use cases and applications. Such technological improvements may be associated with new frequency band expansion, licensed and unlicensed spectrum access, overlapping spectrum use, small cell deployments, non-terrestrial network (NTN) deployments, disaggregated network architectures and network topology expansion, device aggregation, advanced duplex communication, sidelink and other device-to-device direct communication, IoT (including passive or ambient IoT) networks, reduced capability (RedCap) UE functionality, industrial connectivity, multiple-subscriber implementations, high-precision positioning, radio frequency (RF) sensing, and/or artificial intelligence or machine learning (AI/ML), among other examples. These technological improvements may support use cases such as wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples. The methods, operations, apparatuses, and techniques described herein may enable one or more of the foregoing technologies and/or support one or more of the foregoing use cases.

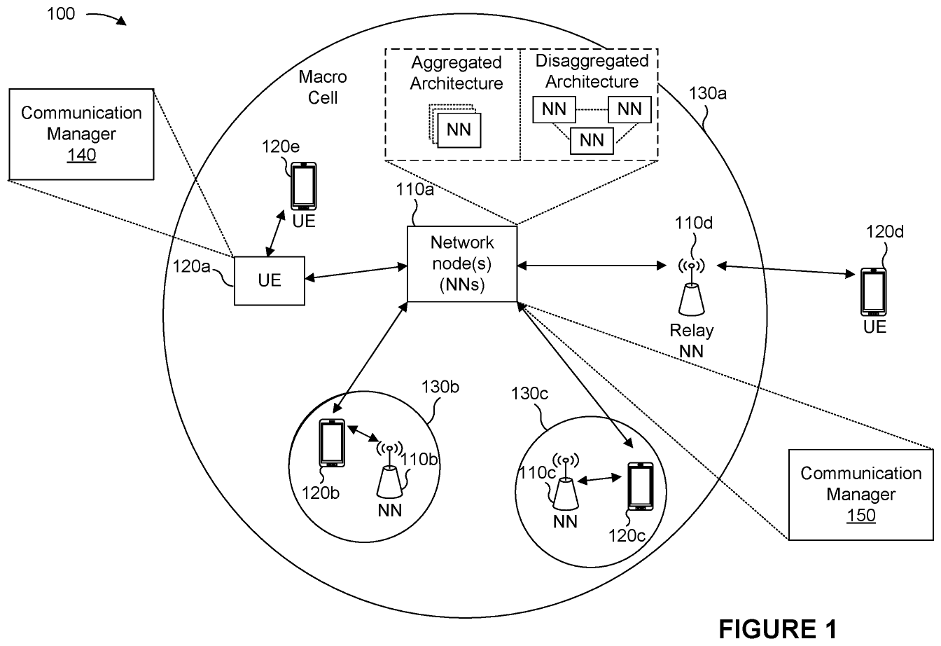

FIG. 1 is a diagram illustrating an example of a wireless communication network 100 in accordance with the present disclosure. The wireless communication network 100 may be or may include elements of a 5G (or NR) network or a 6G network, among other examples. The wireless communication network 100 may include multiple network nodes 110, shown as a network node (NN) 110a, a network node 110b, a network node 110c, and a network node 110d. The network nodes 110 may support communications with multiple UEs 120, shown as a UE 120a, a UE 120b, a UE 120c, a UE 120d, and a UE 120c.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless networks 100 may be deployed in a given geographic area. Each wireless communication network 100 may support a particular RAT (which may also be referred to as an air interface) and may operate on one or more carrier frequencies in one or more frequency ranges. Examples of RATs include a 4G RAT, a 5G/NR RAT, and/or a 6G RAT, among other examples. In some examples, when multiple RATs are deployed in a given geographic area, each RAT in the geographic area may operate on different frequencies to avoid interference with one another.

Various operating bands have been defined as frequency range designations FR1 (410 MHz through 7.125 GHZ), FR2 (24.25 GHz through 52.6 GHZ), FR3 (7.125 GHz through 24.25 GHZ), FR4a or FR4-1 (52.6 GHz through 71 GHZ), FR4 (52.6 GHZ through 114.25 GHZ), and FR5 (114.25 GHz through 300 GHz). Although a portion of FR1 is greater than 6 GHz, FR1 is often referred to (interchangeably) as a “Sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into mid-band frequencies. Thus, “sub-6 GHZ,” if used herein, may broadly refer to frequencies that are less than 6 GHZ, that are within FR1, and/or that are included in mid-band frequencies. Similarly, the term “millimeter wave,” if used herein, may broadly refer to frequencies that are included in mid-band frequencies, that are within FR2, FR4, FR4-a or FR4-1, or FR5, and/or that are within the EHF band. Higher frequency bands may extend 5G NR operation, 6G operation, and/or other RATs beyond 52.6 GHz. For example, each of FR4a, FR4-1, FR4, and FR5 falls within the EHF band. In some examples, the wireless communication network 100 may implement dynamic spectrum sharing (DSS), in which multiple RATs (for example, 4G/LTE and 5G/NR) are implemented with dynamic bandwidth allocation (for example, based on user demand) in a single frequency band. It is contemplated that the frequencies included in these operating bands (for example, FR1, FR2, FR3, FR4, FR4-a, FR4-1, and/or FR5) may be modified, and techniques described herein may be applicable to those modified frequency ranges.

A network node 110 may include one or more devices, components, or systems that enable communication between a UE 120 and one or more devices, components, or systems of the wireless communication network 100. A network node 110 may be, may include, or may also be referred to as an NR network node, a 5G network node, a 6G network node, a Node B, an eNB, a gNB, an access point (AP), a transmission reception point (TRP), a mobility element, a core, a network entity, a network element, a network equipment, and/or another type of device, component, or system included in a radio access network (RAN).

A network node 110 may be implemented as a single physical node (for example, a single physical structure) or may be implemented as two or more physical nodes (for example, two or more distinct physical structures). For example, a network node 110 may be a device or system that implements part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node (having an aggregated architecture), meaning that the network node 110 may implement a full radio protocol stack that is physically and logically integrated within a single node (for example, a single physical structure) in the wireless communication network 100. For example, an aggregated network node 110 may consist of a single standalone base station or a single TRP that uses a full radio protocol stack to enable or facilitate communication between a UE 120 and a core network of the wireless communication network 100.

Alternatively, and as also shown, a network node 110 may be a disaggregated network node (sometimes referred to as a disaggregated base station), meaning that the network node 110 may implement a radio protocol stack that is physically distributed and/or logically distributed among two or more nodes in the same geographic location or in different geographic locations. For example, a disaggregated network node may have a disaggregated architecture. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating base station functionality into multiple units that can be individually deployed.

The network nodes 110 of the wireless communication network 100 may include one or more central units (CUs), one or more distributed units (DUs), and/or one or more radio units (RUS). A CU may host one or more higher layer control functions, such as radio resource control (RRC) functions, packet data convergence protocol (PDCP) functions, and/or service data adaptation protocol (SDAP) functions, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host one or more lower PHY layer functions, such as a fast Fourier transform (FFT), an inverse FFT (IFFT), beamforming, physical random access channel (PRACH) extraction and filtering, and/or scheduling of resources for one or more UEs 120, among other examples. An RU may host RF processing functions or lower PHY layer functions, such as an FFT, an iFFT, beamforming, or PRACH extraction and filtering, among other examples, according to a functional split, such as a lower layer functional split. In such an architecture, each RU can be operated to handle over the air (OTA) communication with one or more UEs 120.

In some aspects, a single network node 110 may include a combination of one or more CUs, one or more DUs, and/or one or more RUs. Additionally or alternatively, a network node 110 may include one or more Near-Real Time (Near-RT) RAN Intelligent Controllers (RICs) and/or one or more Non-Real Time (Non-RT) RICs. In some examples, a CU, a DU, and/or an RU may be implemented as a virtual unit, such as a virtual central unit (VCU), a virtual distributed unit (VDU), or a virtual radio unit (VRU), among other examples. A virtual unit may be implemented as a virtual network function, such as associated with a cloud deployment.

Some network nodes 110 (for example, a base station, an RU, or a TRP) may provide communication coverage for a particular geographic area. In the 3GPP, the term “cell” can refer to a coverage area of a network node 110 or to a network node 110 itself, depending on the context in which the term is used. A network node 110 may support one or multiple (for example, three) cells. In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In some examples, a cell may not necessarily be stationary. For example, the geographic area of the cell may move according to the location of an associated mobile network node 110 (for example, a train, a satellite base station, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. In the example shown in FIG. 1, the network node 110a may be a macro network node for a macro cell 130a, the network node 110b may be a pico network node for a pico cell 130b, and the network node 110c may be a femto network node for a femto cell 130c. Various different types of network nodes 110 may generally transmit at different power levels, serve different coverage areas, and/or have different impacts on interference in the wireless communication network 100 than other types of network nodes 110. For example, macro network nodes may have a high transmit power level (for example, 5 to 40 watts), whereas pico network nodes, femto network nodes, and relay network nodes may have lower transmit power levels (for example, 0.1 to 2 watts).

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink channels may include one or more control channels and one or more data channels. A downlink control channel may be used to transmit downlink control information (DCI) (for example, scheduling information, reference signals, and/or configuration information) from a network node 110 to a UE 120. A downlink data channel may be used to transmit downlink data (for example, user data associated with a UE 120) from a network node 110 to a UE 120. Downlink control channels may include one or more physical downlink control channels (PDCCHs), and downlink data channels may include one or more physical downlink shared channels (PDSCHs). Uplink channels may similarly include one or more control channels and one or more data channels. An uplink control channel may be used to transmit uplink control information (UCI) (for example, reference signals and/or feedback corresponding to one or more downlink transmissions) from a UE 120 to a network node 110. An uplink data channel may be used to transmit uplink data (for example, user data associated with a UE 120) from a UE 120 to a network node 110. Uplink control channels may include one or more physical uplink control channels (PUCCHs), and uplink data channels may include one or more physical uplink shared channels (PUSCHs). The downlink and the uplink may each include a set of resources on which the network node 110 and the UE 120 may communicate.

Downlink and uplink resources may include time domain resources (frames, subframes, slots, and/or symbols), frequency domain resources (frequency bands, component carriers, subcarriers, resource blocks, and/or resource elements), and/or spatial domain resources (particular transmit directions and/or beam parameters). Frequency domain resources of some bands may be subdivided into bandwidth parts (BWPs). A BWP may be a continuous block of frequency domain resources (for example, a continuous block of resource blocks) that are allocated for one or more UEs 120. A UE 120 may be configured with both an uplink BWP and a downlink BWP (where the uplink BWP and the downlink BWP may be the same BWP or different BWPs). A BWP may be dynamically configured (for example, by a network node 110 transmitting a DCI configuration to the one or more UEs 120) and/or reconfigured, which means that a BWP can be adjusted in real-time (or near-real-time) based on changing network conditions in the wireless communication network 100 and/or based on the specific requirements of the one or more UEs 120. This enables more efficient use of the available frequency domain resources in the wireless communication network 100 because fewer frequency domain resources may be allocated to a BWP for a UE 120 (which may reduce the quantity of frequency domain resources that a UE 120 is required to monitor), leaving more frequency domain resources to be spread across multiple UEs 120. Thus, BWPs may also assist in the implementation of lower-capability UEs 120 by facilitating the configuration of smaller bandwidths for communication by such UEs 120.

As described above, in some aspects, the wireless communication network 100 may be, may include, or may be included in, an IAB network. In an IAB network, at least one network node 110 is an anchor network node that communicates with a core network. An anchor network node 110 may also be referred to as an IAB donor (or “IAB-donor”). The anchor network node 110 may connect to the core network via a wired backhaul link. For example, an Ng interface of the anchor network node 110 may terminate at the core network. Additionally or alternatively, an anchor network node 110 may connect to one or more devices of the core network that provide a core access and mobility management function (AMF). An IAB network also generally includes multiple non-anchor network nodes 110, which may also be referred to as relay network nodes or simply as IAB nodes (or “IAB-nodes”). Each non-anchor network node 110 may communicate directly with the anchor network node 110 via a wireless backhaul link to access the core network, or may communicate indirectly with the anchor network node 110 via one or more other non-anchor network nodes 110 and associated wireless backhaul links that form a backhaul path to the core network. Some anchor network node 110 or other non-anchor network node 110 may also communicate directly with one or more UEs 120 via wireless access links that carry access traffic. In some examples, network resources for wireless communication (such as time resources, frequency resources, and/or spatial resources) may be shared between access links and backhaul links.

In some examples, any network node 110 that relays communications may be referred to as a relay network node, a relay station, or simply as a relay. A relay may receive a transmission of a communication from an upstream station (for example, another network node 110 or a UE 120) and transmit the communication to a downstream station (for example, a UE 120 or another network node 110). In this case, the wireless communication network 100 may include or be referred to as a “multi-hop network.” In the example shown in FIG. 1, the network node 110d (for example, a relay network node) may communicate with the network node 110a (for example, a macro network node) and the UE 120d in order to facilitate communication between the network node 110a and the UE 120d. Additionally or alternatively, a UE 120 may be or may operate as a relay station that can relay transmissions to or from other UEs 120. A UE 120 that relays communications may be referred to as a UE relay or a relay UE, among other examples.

The UEs 120 may be physically dispersed throughout the wireless communication network 100, and each UE 120 may be stationary or mobile. A UE 120 may be, may include, or may be included in an access terminal, another terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, and/or smart jewelry, such as a smart ring or a smart bracelet), an entertainment device (for example, a music device, a video device, and/or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

A UE 120 and/or a network node 110 may include one or more chips, system-on-chips (SoCs), chipsets, packages, or devices that individually or collectively constitute or comprise a processing system. The processing system includes processor (or “processing”) circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set, or may include the group of processors all being configured or configurable to perform the set of functions.

The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code (such as software) that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains or transceivers. The UE 120 may include or may be included in a housing that houses components associated with the UE 120 including the processing system.

Some UEs 120 may be considered machine-type communication (MTC) UEs, evolved or enhanced machine-type communication (eMTC), UEs, further enhanced eMTC (feMTC) UEs, or enhanced feMTC (efeMTC) UEs, or further evolutions thereof, all of which may be simply referred to as “MTC UEs”. An MTC UE may be, may include, or may be included in or coupled with a robot, an uncrewed aerial vehicle, a remote device, a sensor, a meter, a monitor, and/or a location tag. Some UEs 120 may be considered IoT devices and/or may be implemented as NB-IoT (narrowband IoT) devices. An IoT UE or NB-IoT device may be, may include, or may be included in or coupled with an industrial machine, an appliance, a refrigerator, a doorbell camera device, a home automation device, and/or a light fixture, among other examples. Some UEs 120 may be considered Customer Premises Equipment, which may include telecommunications devices that are installed at a customer location (such as a home or office) to enable access to a service provider's network (such as included in or in communication with the wireless communication network 100).

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, enhanced mobile broadband (cMBB), and/or precise positioning in the wireless communication network 100, among other examples. A third category of UEs 120 may have mid-tier complexity and/or capability (for example, a capability between UEs 120 of the first category and UEs 120 of the second capability). A UE 120 of the third category may be referred to as a reduced capacity UE (“RedCap UE”), a mid-tier UE, an NR-Light UE, and/or an NR-Lite UE, among other examples. RedCap UEs may bridge a gap between the capability and complexity of NB-IoT devices and/or cMTC UEs, and mission-critical IoT devices and/or premium UEs. RedCap UEs may include, for example, wearable devices, IoT devices, industrial sensors, and/or cameras that are associated with a limited bandwidth, power capacity, and/or transmission range, among other examples. RedCap UEs may support healthcare environments, building automation, electrical distribution, process automation, transport and logistics, and/or smart city deployments, among other examples.

In some examples, two or more UEs 120 (for example, shown as UE 120a and UE 120c) may communicate directly with one another using sidelink communications (for example, without communicating by way of a network node 110 as an intermediary). As an example, the UE 120a may directly transmit data, control information, or other signaling as a sidelink communication to the UE 120c. This is in contrast to, for example, the UE 120a first transmitting data in an UL communication to a network node 110, which then transmits the data to the UE 120c in a DL communication. In various examples, the UEs 120 may transmit and receive sidelink communications using peer-to-peer (P2P) communication protocols, device-to-device (D2D) communication protocols, vehicle-to-everything (V2X) communication protocols (which may include vehicle-to-vehicle (V2V) protocols, vehicle-to-infrastructure (V2I) protocols, and/or vehicle-to-pedestrian (V2P) protocols), and/or mesh network communication protocols. In some deployments and configurations, a network node 110 may schedule and/or allocate resources for sidelink communications between UEs 120 in the wireless communication network 100. In some other deployments and configurations, a UE 120 (instead of a network node 110) may perform, or collaborate or negotiate with one or more other UEs to perform, scheduling operations, resource selection operations, and/or other operations for sidelink communications.

In various examples, some of the network nodes 110 and the UEs 120 of the wireless communication network 100 may be configured for full-duplex operation in addition to half-duplex operation. A network node 110 or a UE 120 operating in a half-duplex mode may perform only one of transmission or reception during particular time resources, such as during particular slots, symbols, or other time periods. Half-duplex operation may involve time-division duplexing (TDD), in which DL transmissions of the network node 110 and UL transmissions of the UE 120 do not occur in the same time resources (that is, the transmissions do not overlap in time). In contrast, a network node 110 or a UE 120 operating in a full-duplex mode can transmit and receive communications concurrently (for example, in the same time resources). By operating in a full-duplex mode, network nodes 110 and/or UEs 120 may generally increase the capacity of the network and the radio access link. In some examples, full-duplex operation may involve frequency-division duplexing (FDD), in which DL transmissions of the network node 110 are performed in a first frequency band or on a first component carrier and transmissions of the UE 120 are performed in a second frequency band or on a second component carrier different than the first frequency band or the first component carrier, respectively. In some examples, full-duplex operation may be enabled for a UE 120 but not for a network node 110. For example, a UE 120 may simultaneously transmit an UL transmission to a first network node 110 and receive a DL transmission from a second network node 110 in the same time resources. In some other examples, full-duplex operation may be enabled for a network node 110 but not for a UE 120. For example, a network node 110 may simultaneously transmit a DL transmission to a first UE 120 and receive an UL transmission from a second UE 120 in the same time resources. In some other examples, full-duplex operation may be enabled for both a network node 110 and a UE 120.

In some examples, the UEs 120 and the network nodes 110 may perform MIMO communication. “MIMO” generally refers to transmitting or receiving multiple signals (such as multiple layers or multiple data streams) simultaneously over the same time and frequency resources. MIMO techniques generally exploit multipath propagation. MIMO may be implemented using various spatial processing or spatial multiplexing operations. In some examples, MIMO may support simultaneous transmission to multiple receivers, referred to as multi-user MIMO (MU-MIMO). Some RATs may employ advanced MIMO techniques, such as mTRP operation (including redundant transmission or reception on multiple TRPs), reciprocity in the time domain or the frequency domain, single-frequency-network (SFN) transmission, or non-coherent joint transmission (NC-JT).

In some aspects, the UE 120 may include a communication manager 140. As described in more detail elsewhere herein, the communication manager 140 may map a pair of bits associated with a channel code to a modulation symbol that corresponds to a point in a constellation that includes a plurality of points, there being non-uniform distances between adjacent points of the plurality of points; and transmit a signal that conveys the modulation symbol to a receiver (for example, a network node 110 or another UE 120). Additionally or alternatively, the communication manager 140 may perform one or more other operations described herein.

In some aspects, the network node 110 may include a communication manager 150. As described in more detail elsewhere herein, the communication manager 150 may map a pair of bits associated with a channel code to a modulation symbol that corresponds to a point in a constellation that includes a plurality of points, there being non-uniform distances between adjacent points of the plurality of points; and transmit a signal that conveys the modulation symbol to a receiver (for example, a UE 120 or another network node 110). Additionally or alternatively, the communication manager 150 may perform one or more other operations described herein.

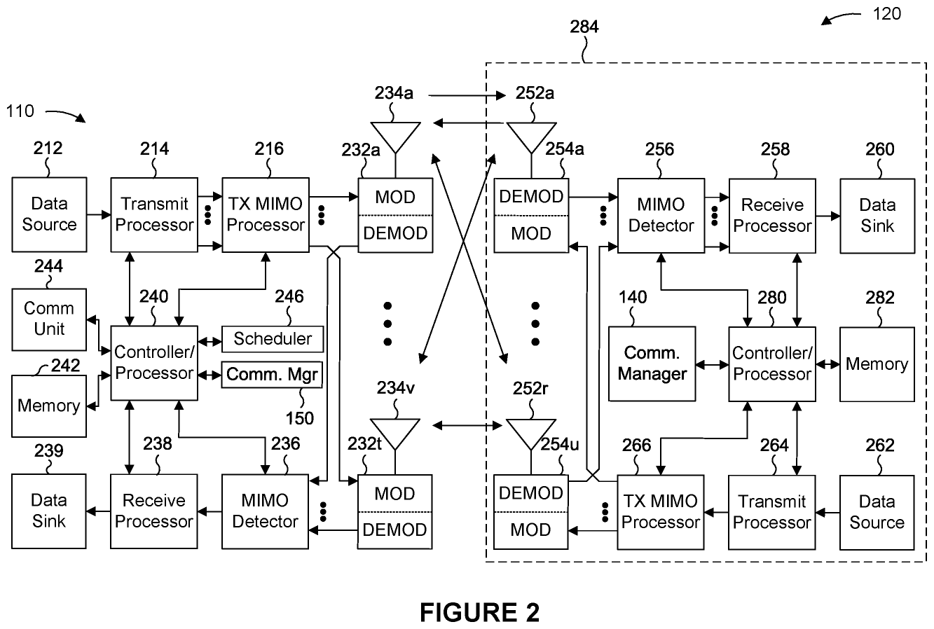

FIG. 2 is a diagram illustrating an example network node 110 in communication with an example UE 120 in a wireless network in accordance with the present disclosure.

As shown in FIG. 2, the network node 110 may include a data source 212, a transmit processor 214, a transmit (TX) MIMO processor 216, a set of modems 232 (shown as 232a through 232t, where t≥1), a set of antennas 234 (shown as 234a through 234v, where v≥1), a MIMO detector 236, a receive processor 238, a data sink 239, a controller/processor 240, a memory 242, a communication unit 244, a scheduler 246, and/or a communication manager 150, among other examples. In some configurations, one or a combination of the antenna(s) 234, the modem(s) 232, the MIMO detector 236, the receive processor 238, the transmit processor 214, and/or the TX MIMO processor 216 may be included in a transceiver of the network node 110. The transceiver may be under control of and used by one or more processors, such as the controller/processor 240, and in some aspects in conjunction with processor-readable code stored in the memory 242, to perform aspects of the methods, processes, and/or operations described herein. In some aspects, the network node 110 may include one or more interfaces, communication components, and/or other components that facilitate communication with the UE 120 or another network node.

The terms “processor,” “controller,” or “controller/processor” may refer to one or more controllers and/or one or more processors. For example, reference to “a/the processor,” “a/the controller/processor,” or the like (in the singular) should be understood to refer to any one or more of the processors described in connection with FIG. 2, such as a single processor or a combination of multiple different processors. Reference to “one or more processors” should be understood to refer to any one or more of the processors described in connection with FIG. 2. For example, one or more processors of the network node 110 may include transmit processor 214, TX MIMO processor 216, MIMO detector 236, receive processor 238, and/or controller/processor 240. Similarly, one or more processors of the UE 120 may include MIMO detector 256, receive processor 258, transmit processor 264, TX MIMO processor 266, and/or controller/processor 280.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “one or more memories” should be understood to refer to any one or more memories of a corresponding device, such as the memory described in connection with FIG. 2. For example, operation described as being performed by one or more memories can be performed by the same subset of the one or more memories or different subsets of the one or more memories.

For downlink communication from the network node 110 to the UE 120, the transmit processor 214 may receive data (“downlink data”) intended for the UE 120 (or a set of UEs that includes the UE 120) from the data source 212 (such as a data pipeline or a data queue). In some examples, the transmit processor 214 may select one or more MCSs for the UE 120 in accordance with one or more channel quality indicators (CQIs) received from the UE 120. The network node 110 may process the data (for example, including encoding the data) for transmission to the UE 120 on a downlink in accordance with the MCS(s) selected for the UE 120 to generate data symbols. The transmit processor 214 may process system information (for example, semi-static resource partitioning information (SRPI)) and/or control information (for example, CQI requests, grants, and/or upper layer signaling) and provide overhead symbols and/or control symbols. The transmit processor 214 may generate reference symbols for reference signals (for example, a cell-specific reference signal (CRS), a demodulation reference signal (DMRS), or a channel state information (CSI) reference signal (CSI-RS)) and/or synchronization signals (for example, a primary synchronization signal (PSS) or a secondary synchronization signals (SSS)).

The TX MIMO processor 216 may perform spatial processing (for example, precoding) on the data symbols, the control symbols, the overhead symbols, and/or the reference symbols, if applicable, and may provide a set of output symbol streams (for example, T output symbol streams) to the set of modems 232. For example, each output symbol stream may be provided to a respective modulator component (shown as MOD) of a modem 232. Each modem 232 may use the respective modulator component to process (for example, to modulate) a respective output symbol stream (for example, for orthogonal frequency division multiplexing (OFDM)) to obtain an output sample stream. Each modem 232 may further use the respective modulator component to process (for example, convert to analog, amplify, filter, and/or upconvert) the output sample stream to obtain a time domain downlink signal. The modems 232a through 232t may together transmit a set of downlink signals (for example, T downlink signals) via the corresponding set of antennas 234.

A downlink signal may include a DCI communication, a MAC control element (MAC-CE) communication, an RRC communication, a downlink reference signal, or another type of downlink communication. Downlink signals may be transmitted on a PDCCH, a PDSCH, and/or on another downlink channel. A downlink signal may carry one or more transport blocks (TBs) of data. A TB may be a unit of data that is transmitted over an air interface in the wireless communication network 100. A data stream (for example, from the data source 212) may be encoded into multiple TBs for transmission over the air interface. The quantity of TBs used to carry the data associated with a particular data stream may be associated with a TB size common to the multiple TBs. The TB size may be based on or otherwise associated with radio channel conditions of the air interface, the MCS used for encoding the data, the downlink resources allocated for transmitting the data, and/or another parameter. In general, the larger the TB size, the greater the amount of data that can be transmitted in a single transmission, which reduces signaling overhead. However, larger TB sizes may be more prone to transmission and/or reception errors than smaller TB sizes, but such errors may be mitigated by more robust error correction techniques.

For uplink communication from the UE 120 to the network node 110, uplink signals from the UE 120 may be received by an antenna 234, may be processed by a modem 232 (for example, a demodulator component, shown as DEMOD, of a modem 232), may be detected by the MIMO detector 236 (for example, a receive (Rx) MIMO processor) if applicable, and/or may be further processed by the receive processor 238 to obtain decoded data and/or control information. The receive processor 238 may provide the decoded data to a data sink 239 (which may be a data pipeline, a data queue, and/or another type of data sink) and provide the decoded control information to a processor, such as the controller/processor 240.

The network node 110 may use the scheduler 246 to schedule one or more UEs 120 for downlink or uplink communications. In some aspects, the scheduler 246 may use DCI to dynamically schedule DL transmissions to the UE 120 and/or UL transmissions from the UE 120. In some examples, the scheduler 246 may allocate recurring time domain resources and/or frequency domain resources that the UE 120 may use to transmit and/or receive communications using an RRC configuration (for example, a semi-static configuration), for example, to perform semi-persistent scheduling (SPS) or to configure a configured grant (CG) for the UE 120.

One or more of the transmit processor 214, the TX MIMO processor 216, the modem 232, the antenna 234, the MIMO detector 236, the receive processor 238, and/or the controller/processor 240 may be included in an RF chain of the network node 110. An RF chain may include one or more filters, mixers, oscillators, amplifiers, analog-to-digital converters (ADCs), and/or other devices that convert between an analog signal (such as for transmission or reception via an air interface) and a digital signal (such as for processing by one or more processors of the network node 110). In some aspects, the RF chain may be or may be included in a transceiver of the network node 110.

In some examples, the network node 110 may use the communication unit 244 to communicate with a core network and/or with other network nodes. The communication unit 244 may support wired and/or wireless communication protocols and/or connections, such as Ethernet, optical fiber, common public radio interface (CPRI), and/or a wired or wireless backhaul, among other examples. The network node 110 may use the communication unit 244 to transmit and/or receive data associated with the UE 120 or to perform network control signaling, among other examples. The communication unit 244 may include a transceiver and/or an interface, such as a network interface.

The UE 120 may include a set of antennas 252 (shown as antennas 252a through 252r, where r≥1), a set of modems 254 (shown as modems 254a through 254u, where u≥1), a MIMO detector 256, a receive processor 258, a data sink 260, a data source 262, a transmit processor 264, a TX MIMO processor 266, a controller/processor 280, a memory 282, and/or a communication manager 140, among other examples. One or more of the components of the UE 120 may be included in a housing 284. In some aspects, one or a combination of the antenna(s) 252, the modem(s) 254, the MIMO detector 256, the receive processor 258, the transmit processor 264, or the TX MIMO processor 266 may be included in a transceiver that is included in the UE 120. The transceiver may be under control of and used by one or more processors, such as the controller/processor 280, and in some aspects in conjunction with processor-readable code stored in the memory 282, to perform aspects of the methods, processes, or operations described herein. In some aspects, the UE 120 may include another interface, another communication component, and/or another component that facilitates communication with the network node 110 and/or another UE 120.

For downlink communication from the network node 110 to the UE 120, the set of antennas 252 may receive the downlink communications or signals from the network node 110 and may provide a set of received downlink signals (for example, R received signals) to the set of modems 254. For example, each received signal may be provided to a respective demodulator component (shown as DEMOD) of a modem 254. Each modem 254 may use the respective demodulator component to condition (for example, filter, amplify, downconvert, and/or digitize) a received signal to obtain input samples. Each modem 254 may use the respective demodulator component to further demodulate or process the input samples (for example, for OFDM) to obtain received symbols. The MIMO detector 256 may obtain received symbols from the set of modems 254, may perform MIMO detection on the received symbols if applicable, and may provide detected symbols. The receive processor 258 may process (for example, decode) the detected symbols, may provide decoded data for the UE 120 to the data sink 260 (which may include a data pipeline, a data queue, and/or an application executed on the UE 120), and may provide decoded control information and system information to the controller/processor 280.

For uplink communication from the UE 120 to the network node 110, the transmit processor 264 may receive and process data (“uplink data”) from a data source 262 (such as a data pipeline, a data queue, and/or an application executed on the UE 120) and control information from the controller/processor 280. The control information may include one or more parameters, feedback, one or more signal measurements, and/or other types of control information. In some aspects, the receive processor 258 and/or the controller/processor 280 may determine, for a received signal (such as received from the network node 110 or another UE), one or more parameters relating to transmission of the uplink communication. The one or more parameters may include a reference signal received power (RSRP) parameter, a received signal strength indicator (RSSI) parameter, a reference signal received quality (RSRQ) parameter, a CQI parameter, or a transmit power control (TPC) parameter, among other examples. The control information may include an indication of the RSRP parameter, the RSSI parameter, the RSRQ parameter, the CQI parameter, the TPC parameter, and/or another parameter. The control information may facilitate parameter selection and/or scheduling for the UE 120 by the network node 110.

The transmit processor 264 may generate reference symbols for one or more reference signals, such as an uplink DMRS, an uplink sounding reference signal (SRS), and/or another type of reference signal. The symbols from the transmit processor 264 may be precoded by the TX MIMO processor 266, if applicable, and further processed by the set of modems 254 (for example, for DFT-s-OFDM or CP-OFDM). The TX MIMO processor 266 may perform spatial processing (for example, precoding) on the data symbols, the control symbols, the overhead symbols, and/or the reference symbols, if applicable, and may provide a set of output symbol streams (for example, U output symbol streams) to the set of modems 254. For example, each output symbol stream may be provided to a respective modulator component (shown as MOD) of a modem 254. Each modem 254 may use the respective modulator component to process (for example, to modulate) a respective output symbol stream (for example, for OFDM) to obtain an output sample stream. Each modem 254 may further use the respective modulator component to process (for example, convert to analog, amplify, filter, and/or upconvert) the output sample stream to obtain an uplink signal.

The modems 254a through 254u may transmit a set of uplink signals (for example, R uplink signals or U uplink symbols) via the corresponding set of antennas 252. An uplink signal may include a UCI communication, a MAC-CE communication, an RRC communication, or another type of uplink communication. Uplink signals may be transmitted on a PUSCH, a PUCCH, and/or another type of uplink channel. An uplink signal may carry one or more TBs of data. Sidelink data and control transmissions (that is, transmissions directly between two or more UEs 120) may generally use similar techniques as were described for uplink data and control transmission, and may use sidelink-specific channels such as a physical sidelink shared channel (PSSCH), a physical sidelink control channel (PSCCH), and/or a physical sidelink feedback channel (PSFCH).

One or more antennas of the set of antennas 252 or the set of antennas 234 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. As used herein, “antenna” can refer to one or more antennas, one or more antenna panels, one or more antenna groups, one or more sets of antenna elements, or one or more antenna arrays. “Antenna panel” can refer to a group of antennas (such as antenna elements) arranged in an array or panel, which may facilitate beamforming by manipulating parameters of the group of antennas. “Antenna module” may refer to circuitry including one or more antennas, which may also include one or more other components (such as filters, amplifiers, or processors) associated with integrating the antenna module into a wireless communication device.

In some examples, each of the antenna elements of an antenna 234 or an antenna 252 may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range.

The amplitudes and/or phases of signals transmitted via antenna elements and/or sub-elements may be modulated and shifted relative to each other (such as by manipulating phase shift, phase offset, and/or amplitude) to generate one or more beams, which is referred to as beamforming. The term “beam” may refer to a directional transmission of a wireless signal toward a receiving device or otherwise in a desired direction. “Beam” may also generally refer to a direction associated with such a directional signal transmission, a set of directional resources associated with the signal transmission (for example, an angle of arrival, a horizontal direction, and/or a vertical direction), and/or a set of parameters that indicate one or more aspects of a directional signal, a direction associated with the signal, and/or a set of directional resources associated with the signal. In some implementations, antenna elements may be individually selected or deselected for directional transmission of a signal (or signals) by controlling amplitudes of one or more corresponding amplifiers and/or phases of the signal(s) to form one or more beams. The shape of a beam (such as the amplitude, width, and/or presence of side lobes) and/or the direction of a beam (such as an angle of the beam relative to a surface of an antenna array) can be dynamically controlled by modifying the phase shifts, phase offsets, and/or amplitudes of the multiple signals relative to each other.

Different UEs 120 or network nodes 110 may include different numbers of antenna elements. For example, a UE 120 may include a single antenna element, two antenna elements, four antenna elements, eight antenna elements, or a different number of antenna elements. As another example, a network node 110 may include eight antenna elements, 24 antenna elements, 64 antenna elements, 128 antenna elements, or a different number of antenna elements. Generally, a larger number of antenna elements may provide increased control over parameters for beam generation relative to a smaller number of antenna elements, whereas a smaller number of antenna elements may be less complex to implement and may use less power than a larger number of antenna elements. Multiple antenna elements may support multiple-layer transmission, in which a first layer of a communication (which may include a first data stream) and a second layer of a communication (which may include a second data stream) are transmitted using the same time and frequency resources with spatial multiplexing.

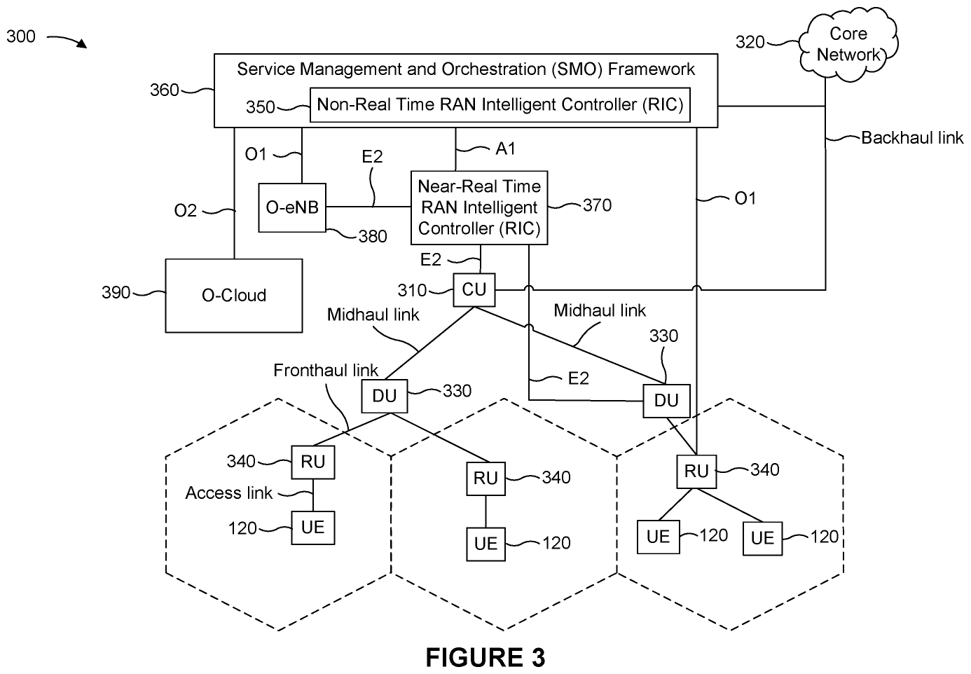

FIG. 3 is a diagram illustrating an example disaggregated base station architecture 300 in accordance with the present disclosure. One or more components of the example disaggregated base station architecture 300 may be, may include, or may be included in one or more network nodes (such one or more network nodes 110). The disaggregated base station architecture 300 may include a CU 310 that can communicate directly with a core network 320 via a backhaul link, or that can communicate indirectly with the core network 320 via one or more disaggregated control units, such as a Non-RT RIC 350 associated with a Service Management and Orchestration (SMO) Framework 360 and/or a Near-RT RIC 370 (for example, via an E2 link). The CU 310 may communicate with one or more DUs 330 via respective midhaul links, such as via F1 interfaces. Each of the DUs 330 may communicate with one or more RUs 340 via respective fronthaul links. Each of the RUs 340 may communicate with one or more UEs 120 via respective RF access links. In some deployments, a UE 120 may be simultaneously served by multiple RUs 340.

Each of the components of the disaggregated base station architecture 300, including the CUs 310, the DUs 330, the RUs 340, the Near-RT RICs 370, the Non-RT RICs 350, and the SMO Framework 360, may include one or more interfaces or may be coupled with one or more interfaces for receiving or transmitting signals, such as data or information, via a wired or wireless transmission medium.

In some aspects, the CU 310 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 310 may be deployed to communicate with one or more DUs 330, as necessary, for network control and signaling. Each DU 330 may correspond to a logical unit that includes one or more base station functions to control the operation of one or more RUs 340. For example, a DU 330 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 330, or for communicating signals with the control functions hosted by the CU 310. Each RU 340 may implement lower layer functionality. In some aspects, real-time and non-real-time aspects of control and user plane communication with the RU(s) 340 may be controlled by the corresponding DU 330.

The SMO Framework 360 may support RAN deployment and provisioning of non-virtualized and virtualized network elements. For non-virtualized network elements, the SMO Framework 360 may support the deployment of dedicated physical resources for RAN coverage requirements, which may be managed via an operations and maintenance interface, such as an O1 interface. For virtualized network elements, the SMO Framework 360 may interact with a cloud computing platform (such as an open cloud (O-Cloud) platform 390) to perform network element life cycle management (such as to instantiate virtualized network elements) via a cloud computing platform interface, such as an O2 interface. A virtualized network element may include, but is not limited to, a CU 310, a DU 330, an RU 340, a non-RT RIC 350, and/or a Near-RT RIC 370. In some aspects, the SMO Framework 360 may communicate with a hardware aspect of a 4G RAN, a 5G NR RAN, and/or a 6G RAN, such as an open eNB (O-cNB) 380, via an O1 interface. Additionally or alternatively, the SMO Framework 360 may communicate directly with each of one or more RUs 340 via a respective O1 interface. In some deployments, this configuration can enable each DU 330 and the CU 310 to be implemented in a cloud-based RAN architecture, such as a vRAN architecture.

The Non-RT RIC 350 may include or may implement a logical function that enables non-real-time control and optimization of RAN elements and resources, AI/ML workflows including model training and updates, and/or policy-based guidance of applications and/or features in the Near-RT RIC 370. The Non-RT RIC 350 may be coupled to or may communicate with (such as via an A1 interface) the Near-RT RIC 370. The Near-RT RIC 370 may include or may implement a logical function that enables near-real-time control and optimization of RAN elements and resources via data collection and actions via an interface (such as via an E2 interface) connecting one or more CUs 310, one or more DUs 330, and/or an O-eNB with the Near-RT RIC 370.

In some aspects, to generate AI/ML models to be deployed in the Near-RT RIC 370, the Non-RT RIC 350 may receive parameters or external enrichment information from external servers. Such information may be utilized by the Near-RT RIC 370 and may be received at the SMO Framework 360 or the Non-RT RIC 350 from non-network data sources or from network functions. In some examples, the Non-RT RIC 350 or the Near-RT RIC 370 may tune RAN behavior or performance. For example, the Non-RT RIC 350 may monitor long-term trends and patterns for performance and may employ AI/ML models to perform corrective actions via the SMO Framework 360 (such as reconfiguration via an O1 interface) or via creation of RAN management policies (such as A1 interface policies).

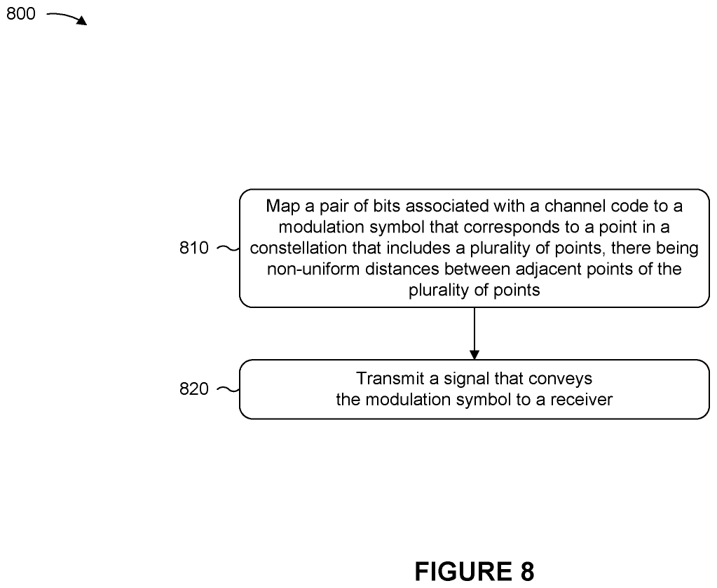

The network node 110, the controller/processor 240 of the network node 110, the UE 120, the controller/processor 280 of the UE 120, the CU 310, the DU 330, the RU 340, or any other component(s) of FIG. 1, 2, or 3 may implement one or more techniques or perform one or more operations associated with a modulation scheme for channel codes, as described in more detail elsewhere herein. For example, the controller/processor 240 of the network node 110, the controller/processor 280 of the UE 120, any other component(s) of FIG. 2, the CU 310, the DU 330, or the RU 340 may perform or direct operations of, for example, process 800 of FIG. 8, or other processes as described herein (alone or in conjunction with one or more other processors). The memory 242 may store data and program codes for the network node 110, the network node 110, the CU 310, the DU 330, or the RU 340. The memory 282 may store data and program codes for the UE 120. In some examples, the memory 242 or the memory 282 may include a non-transitory computer-readable medium storing a set of instructions (for example, code or program code) for wireless communication. The memory 242 may include one or more memories, such as a single memory or multiple different memories (of the same type or of different types). The memory 282 may include one or more memories, such as a single memory or multiple different memories (of the same type or of different types). For example, the set of instructions, when executed (for example, directly, or after compiling, converting, or interpreting) by one or more processors of the network node 110, the UE 120, the CU 310, the DU 330, or the RU 340, may cause the one or more processors to perform process 800 of FIG. 8 or other processes as described herein. In some examples, executing instructions may include running the instructions, converting the instructions, compiling the instructions, and/or interpreting the instructions, among other examples.

In some aspects, a transmitter includes means for mapping a pair of bits associated with a channel code to a modulation symbol that corresponds to a point in a constellation that includes a plurality of points, there being non-uniform distances between adjacent points of the plurality of points; and/or means for transmitting a signal that conveys the modulation symbol to a receiver. In some aspects, the means for the transmitter to perform operations described herein may include, for example, one or more of communication manager 150, transmit processor 214, TX MIMO processor 216, modem 232, antenna 234, MIMO detector 236, receive processor 238, controller/processor 240, memory 242, or scheduler 246. Additionally or alternatively, in some aspects, the means for the transmitter to perform operations described herein may include, for example, one or more of communication manager 140, antenna 252, modem 254, MIMO detector 256, receive processor 258, transmit processor 264, TX MIMO processor 266, controller/processor 280, or memory 282.

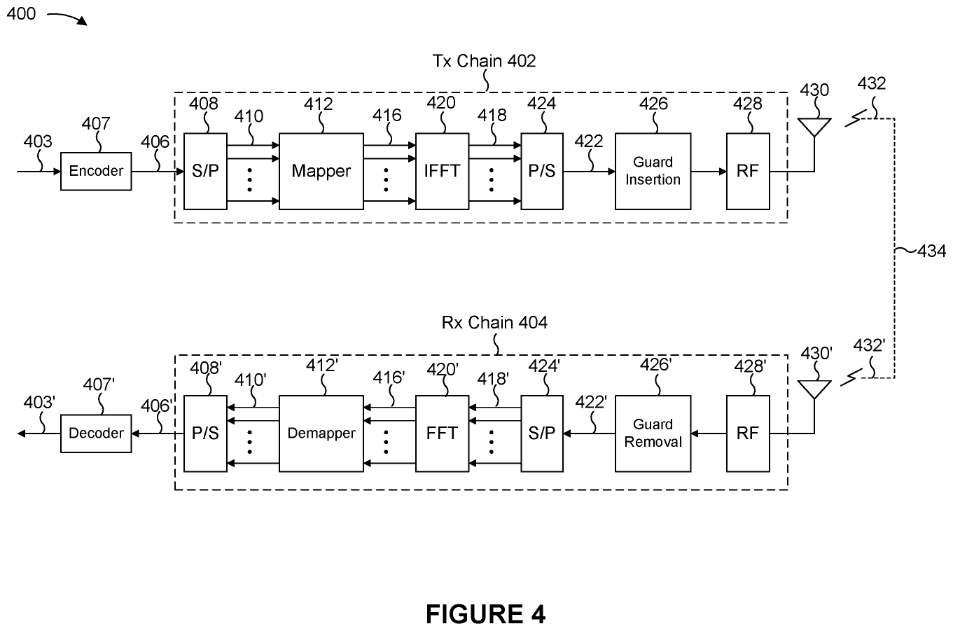

FIG. 4 is a diagram illustrating an example 400 of a transmit (Tx) chain 402 and a receive (Rx) chain 404, in accordance with the present disclosure. In some aspects, one or more components of Tx chain 402 may be implemented in transmit processor 264, TX MIMO processor 266, modem 254, and/or controller/processor 280, as described above in connection with FIG. 2. In some aspects, Tx chain 402 may be implemented in UE 120 for transmitting data 406 (for example, uplink data, an uplink reference signal, and/or uplink control information) to a network node 110 on an uplink channel. Additionally or alternatively, one or more components of Tx chain 402 may be implemented in transmit processor 214, TX MIMO processor 216, modem 232, and/or controller/processor 240, as described above in connection with FIG. 2. In some aspects, Tx chain 402 may be implemented in a network node 110 for transmitting data 406 (for example, downlink data, a downlink reference signal, and/or downlink control information) to a UE 120 on a downlink channel.

An encoder 407 may alter a signal (for example, a bitstream) 403 into data 406. Data 406 to be transmitted is provided from encoder 407 as input to a serial-to-parallel (S/P) converter 408. In some aspects, S/P converter 408 may split the transmission data into N parallel data streams 410.

The N parallel data streams 410 may then be provided as input to a mapper 412. Mapper 412 may map the N parallel data streams 410 onto N constellation points. The mapping may be done using a modulation constellation, such as BPSK, QPSK, 8 phase-shift keying (8PSK), and/or quadrature amplitude modulation (QAM), among other examples. Thus, the mapper 412 may output N parallel symbol streams 416, each symbol stream 416 corresponding to one of N orthogonal subcarriers of an iFFT component 420. The N parallel symbol streams 416 are represented in the frequency domain and may be converted into N parallel time domain sample streams 418 by iFFT component 420.

In some aspects, N parallel modulations in the frequency domain correspond to N modulation symbols in the frequency domain, which are equal to N mapping and N-point iFFT in the frequency domain, which are equal to one (useful) OFDM symbol in the time domain, which are equal to N samples in the time domain. One OFDM symbol in the time domain, Ns, is equal to Nep (the number of guard samples per OFDM symbol)+N (the number of useful samples per OFDM symbol).

The N parallel time domain sample streams 418 may be converted into an OFDM/OFDMA symbol stream 422 by a parallel-to-serial (P/S) converter 424. A guard insertion component 426 may insert a guard interval between successive OFDM/OFDMA symbols in the OFDM/OFDMA symbol stream 422. The output of guard insertion component 426 may then be upconverted to a desired transmit frequency band by an RF front end 428. An antenna 430 may then transmit the resulting signal 432.

In some aspects, Rx chain 404 may utilize OFDM/OFDMA. In some aspects, one or more components of Rx chain 404 may be implemented in receive processor 258, MIMO detector 256, modem 254, and/or controller/processor 280, as described above in connection with FIG. 2. In some aspects, Rx chain 404 may be implemented in UE 120 for receiving data 406 (for example, downlink data, a downlink reference signal, and/or downlink control information) from a network node 110 on a downlink channel. Additionally or alternatively, one or more components of Rx chain 404 may be implemented in receive processor 238, MIMO detector 236, modem 232, and/or controller/processor 240, as described above in connection with FIG. 2. In some aspects, Rx chain 404 may be implemented in network node 120 for receiving data 406 (for example, uplink data, an uplink reference signal, and/or uplink control information) from a UE 120 on an uplink channel.

A transmitted signal 432 is shown traveling over a wireless channel 434 from Tx chain 402 to Rx chain 404 (for example, from a UE 120 to a network node 110, from a network node 110 to a UE 120, and/or from a first UE 120 to a second UE 120, among other examples). When a signal 432′ is received by an antenna 430′, the received signal 432′ may be downconverted to a baseband signal by an RF front end 428′. A guard removal component 426′ may then remove the guard interval that was inserted between OFDM/OFDMA symbols by guard insertion component 426.

The output of guard removal component 426′ may be provided to an S/P converter 424′. The output may include an OFDM/OFDMA symbol stream 422′, and S/P converter 424′ may divide the OFDM/OFDMA symbol stream 422′ into N parallel time-domain symbol streams 418′, each of which corresponds to one of the N orthogonal subcarriers. An FFT component 420′ may convert the N parallel time-domain symbol streams 418′ into the frequency domain and output N parallel frequency-domain symbol streams 416′.

A demapper 412′ may perform the inverse of the symbol mapping operation that was performed by mapper 412, thereby outputting N parallel data streams 410′. A P/S converter 408′ may combine the N parallel data streams 410′ into a single data stream 406′. Ideally, data stream 406′ corresponds to data 406 that was provided as input to Tx chain 402. Data stream 406′ may be decoded into a decoded data stream 403′ by decoder 407′.

The number and arrangement of components shown in FIG. 4 are provided as an example. In practice, there may be additional components, fewer components, different components, or differently arranged components than those shown in FIG. 4. Furthermore, two or more components shown in FIG. 4 may be implemented within a single component, or a single component shown in FIG. 4 may be implemented as multiple, distributed components. Additionally or alternatively, a set of components (for example, one or more components) shown in FIG. 4 may perform one or more functions described as being performed by another set of components shown in FIG. 4.

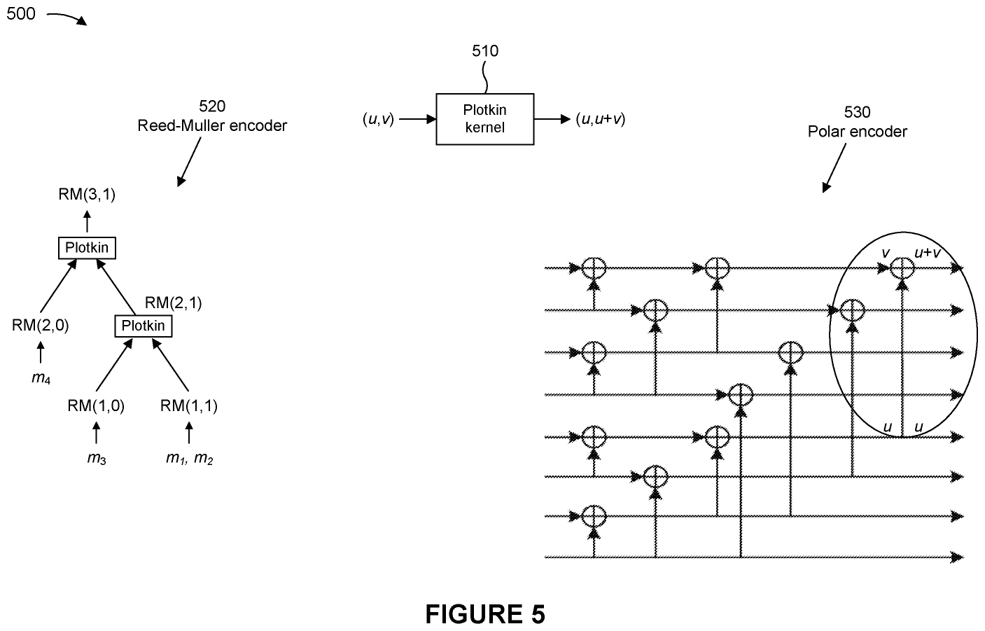

FIG. 5 is a diagram illustrating examples 500 of channel codes in accordance with the present disclosure. In a wireless communication system, information is generally represented as a sequence of binary bits that are mapped (for example, modulated) to an analog signal waveform that is then transmitted to a receiver over a wireless communication channel. In some cases, however, the wireless communication channel may introduce errors that may corrupt the transmitted signal due to random noise, interference, device impairments, and/or other factors. At the receiver, the received signal (that may have been corrupted during transmission) is mapped back to binary bits, with the received binary information estimating the transmitted binary information. Accordingly, because errors may corrupt the signal that is estimated at the receiver, channel coding or forward error correction (FEC) techniques are often used to control errors in data transmission over unreliable or noisy communication channels or otherwise mitigate the bit errors that may occur due to noise, interference, and/or other factors. For example, channel coding generally includes an encoding operation performed at a transmitter (for example, a first wireless device, which may be a UE or a network node) and a decoding operation performed at a receiver (for example, a second wireless device, which may be a UE or a network node). Channel coding is generally accomplished by selectively introducing redundancy into the transmitted information stream, typically using an error correction code (ECC), which allows the receiver to detect errors and/or correct bit errors in the received data stream and thereby provide more reliable information transmission. Accordingly, channel codes are often used in scenarios where retransmissions are undesirable and/or high transmission reliability is needed, such as downlink and/or uplink control channel communications.

As described herein, some channel codes may be generated or encoded using a Plotkin construction technique. For example, FIG. 5 illustrates a Plotkin kernel 510 that may concatenate or combine two codes or subcodes in such a way that a resulting code (for example, a Reed-Muller code and/or a polar code) inherits certain properties from the constituent components. For example, as described herein, Reed-Muller codes are often used when a message has a small payload size (for example, for an uplink control channel when a payload size is less than or equal to a threshold), and polar codes are often used for messages with a larger payload size (for example, for both uplink and downlink control channels when a payload size exceeds the threshold). As shown in FIG. 5, the Plotkin construction is a simple transform function, where a pair of input bits, denoted (u, v), are mapped to two output bits, denoted (u, u+v), with the first output bit being a copy of the first input bit and the second output bit combining the first input bit and the second input bit (for example, according to an exclusive-or (XOR) operation). In this way, the Plotkin construction (for example, a repeat operation and an XOR combination operation) can be performed recursively or iteratively to obtain a channel code with a relatively large error correcting capability.

For example, FIG. 5 illustrates an example Reed-Muller encoder 520 that can be used to generate a Reed-Muller code. For example, a Reed-Muller code with a variable size m and an order r, with r≤m, is generally represented using the expression RM(m, r), which indicates a message length k=Σᵢ₌₀^{r}(ᵢ^{m}) (for example, a number of information bits) and a block length n=2^{m} (for example, a number of transmissions). In some cases, as shown in FIG. 5, a Reed-Muller code may be defined or generated via a recursive application of a Plotkin construction. For example, the Reed-Muller encoder 520 is shown as a Plotkin tree decomposition of an RM(3,1) encoder, where encoding starts from the bottom right leaves. In particular, a leaf RM(1, 0) maps m₃ to (m₃, m₃) (repetition), and another leaf RM(1, 1) maps (m₁, m₂) to (m₁, m₁+m₂) (for example, a Plotkin construction of two RM(0, 0) codes). Each branch in the tree performs the Plotkin construction, and the next operation in the illustrated Reed-Muller encoding is the parent of leaves RM(1, 0) and RM(1, 1) applying the Plotkin construction (RM(1, 1), RM(1, 0))=Plotkin ((m₁, m₁+m₂), (m₃, m₃)), which outputs a vector (m₁, m₁+m₂, m₁+m₃, m₁+m₂+m₃), which is represented as RM(2, 1). This coordinate-wise Plotkin construction is applied recursively again to combine RM(2, 0) and RM(2, 1) at the root of the tree, where the resulting Reed-Muller codewords are RM(3, 1)=Plotkin (RM(2, 1), RM(2, 0))=Plotkin ((m₁, m₁+m₂, m₁+m₃, m₁+m₂+m₃), (m₄, m₄, m₄, m₄)). This recursive structure of Reed-Muller codes inherits a favorable minimum distance property of the Plotkin construction and enables efficient decoding.

In addition, FIG. 5 illustrates an example polar encoder 530, which similarly applies Plotkin constructions in a recursive manner. For example, polar coding generally involves channel combining and channel splitting, where a transmitter performs channel combining to map combinations of bits or symbols to specific channels and channel splitting that includes an implicit transformation operation (for example, analogous to frequency domain to time domain conversion performed by an iFFT operation), to translate the bit/symbol combinations into time domain vectors. As shown in FIG. 5, the polar encoding includes one or more Plotkin constructions that are performed recursively (for example, in a symmetric manner), where a first input bit, u, and a second input bit, v, are XORed (shown by a plus symbol inscribed in a circle) such that a first output bit is a copy of the first input bit and the second output bit is an XOR combination of the first input bit and the second input bit. The decoding operation at a receiver, in symmetry with the polar encoding, estimates the time domain bit streams using a successive-cancellation decoding technique, analogous to spectral domain estimation. Accordingly, polar coding, including channel splitting and successive-cancellation decoding, converts a block of bits and associated channels between the encoder and decoder, into a polarized bit stream at the receiver. That is, a received bit and an associated channel may be associated with either a “good channel” or a “bad channel” pole or category. For example, some bits will experience a bit channel with a BER of zero (corresponding to a capacity of 100%), whereas other bits will experience a bit channel with a BER of 0.5 (corresponding to a capacity of 0%). The proportion of noiseless bit channels converges to a channel capacity (for example, a Shannon capacity). Given a channel with a channel capacity, the indexes of the bit channels can be sorted. To transmit using a rate, a transmitter may transmit data in a best bit channel, which is defined as a bit channel that has a maximal capacity and/or a minimum BER. In the other bits, the encoder may insert fixed values known to the decoder (referred to as frozen bits). The input and output of a polar encoder may be of the same length. Thus, polar codes are a capacity-achieving and practical channel codes.

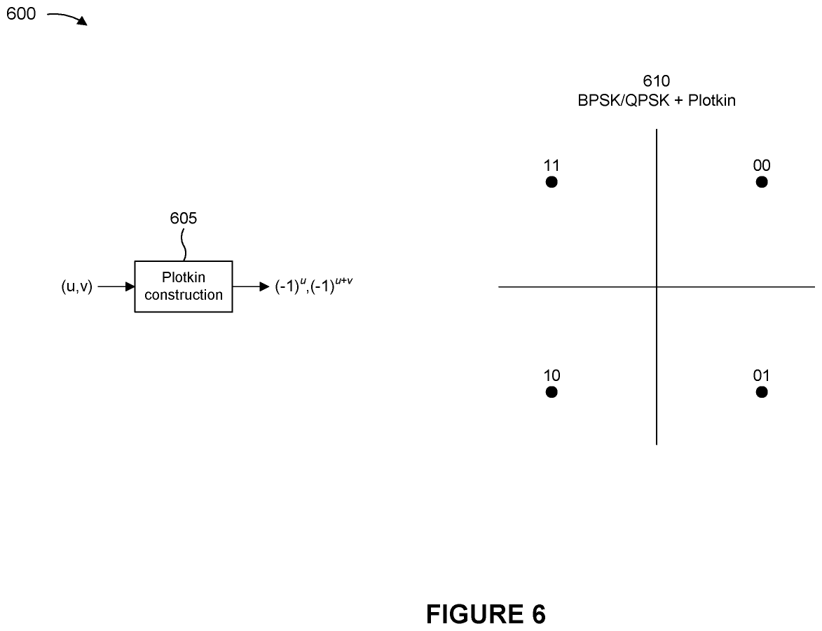

FIG. 6 is a diagram illustrating an example 600 of mapping a channel code to a constellation with equally spaced points in accordance with the present disclosure. In a wireless communication scenario in a relatively low to medium SNR range, Reed-Muller codes, polar codes, and/or other channel codes are often used with a phase-shift keying (PSK) modulation technique, such as BPSK and/or QPSK. More particularly, BPSK/QPSK modulation is typically a square modulation, where two bits are mapped to a complex modulation symbol that corresponds to a single point in a four-point constellation that forms a square (for example, in a coordinate space that includes a horizontal axis to represent an in-phase or real component of the complex modulation symbol and a vertical axis to represent a quadrature or imaginary component of the complex modulation symbol). For example, given two bits, (u, v), to be modulated or mapped to a complex modulation symbol, BPSK/QPSK modulation may use a Plotkin construction 605 to map the two bits to a point in the square constellation as follows:

(u,v) [symbol] [(−1)^{u},(−1)^{u+v}],

where (−1)^{u} is an x-coordinate of the complex modulation symbol (for example, positive 1 when u=0 or negative 1 when u=1) and (−1)^{u+v} is a y-coordinate of the complex modulation symbol (for example, positive 1 when u and v are both equal to 0 or both equal to 1, or negative 1 when either u or v, but not both, are equal to 1). For example, FIG. 6 illustrates an example constellation 610 associated with a BPSK/QPSK+Plotkin mapping, where (u, v)=(0,0) [symbol] [(−1)⁰, (−1)⁰⁺⁰]=(1,1), which maps to the point in the upper-right quadrant. Similarly, (u, v)=(0,1) [symbol] [(−1)⁰, (−1)⁰⁺¹]=(1, −1), which maps to the point in the lower-right quadrant, (u, v)=(1,0) [symbol] [(−1)¹, (−1)¹⁺¹]=(−1, −1), which maps to the point in the lower-left quadrant, and (u, v)=(1,1) [symbol] [(−1)¹, (−1)¹⁺¹]=(−1, 1), which maps to the point in the upper-left quadrant. In this way, using BPSK/QPSK modulation and the Plotkin construction 605 maps the four possible values for the combination of (u, v) to respective points in a four-point constellation with a square shape (for example, a symmetric shape with uniform distances between adjacent points). As shown in FIG. 6, after the Plotkin construction 605 is applied, the mapping from (u, v) to a complex modulation symbol is a non-Gray mapping.

Although BPSK and QPSK modulation schemes exhibit good performance with respect to bit-interleaved coded modulation (BICM) capacity, BPSK/QPSK suffer from drawbacks in cases of channel codes such as Reed-Muller codes or polar codes that typically have a small block length or a code word with a small size. Furthermore, in many cases, a receiver may use a sub-optimal decoder due to practical complexity limitations. For example, the optimal performance associated with BPSK/QPSK modulation in terms of BICM capacity requires infinite block lengths and an ML decoder, which is exponentially more complex than is typically suitable in practical scenarios. Accordingly, in practice, Reed-Muller codes, polar codes, and other channel codes with similar properties (for example, associated with a Plotkin construction) are often decoded using successive cancellation (list) (SC (L)) decoding, which is associated with a decoding performance that generally depends on a weakest point in a decoding chain. For example, in successive cancellation decoding, a decoder first decodes one piece of information and then uses that piece of information to decode a next piece of information, and so on, in a sequential manner. Accordingly, in cases where there is one error in the sequential decoding procedure, decoding will fail for the entire code block. In a square QAM scheme, such as BPSK/QPSK, the four-point constellation design with uniform distances between adjacent points (or uniform distances from an origin of the coordinate space) creates an imbalance between some branches. For example, in a channel code associated with a Plotkin construction, where (u, v) [symbol] (u, u+v), a successive cancellation decoder first decodes v, and then decodes u conditioned on v (for example, u can be decoded when v is known). In other words, BPSK/QPSK modulation and/or other modulation schemes that use square or other fully symmetric constellation shapes create an imbalance between the u component and the v component of a channel code associated with a Plotkin construction, where decoding performance for the v component dominates the overall decoding performance.

Accordingly, various aspects relate generally to a modulation scheme for channel codes that may balance protections on different components of a channel code such that no single component of the channel code dominates overall performance. Some aspects more specifically relate to a modulation scheme that may map a channel code that includes two or more bits to a point in a constellation that is biased toward an asymmetric shape. In some aspects, the constellation includes multiple points in a coordinate space that includes a first (for example, horizontal) axis to represent an in-phase or real component of a complex modulation symbol and a second (for example, vertical) axis to represent a quadrature or imaginary component of the complex modulation symbol, there being non-uniform distances between adjacent points in the constellation. For example, to modulate a pair of bits associated with a channel code, such as a Reed-Muller code or a polar code, the constellation may have exactly four points (each representing a possible combination of values for the pair bits), where each point may have an arbitrary position in the coordinate space. Furthermore, to avoid over-clustering the points in the constellation and thereby improve decoding performance, each quadrant may have an equal quantity of points (for example, one point per quadrant for a four-point constellation associated with a two-bit mapping and/or one point per quadrant and one point on each segment of an axis that separates two quadrants for an eight-point constellation associated with a three-bit mapping, among other examples). In some aspects, the constellation may have a shape that is asymmetric with respect to both axes of the coordinate space, or the constellation may have a shape (for example, a trapezoidal or triangular shape) that is asymmetric with respect to one axis of the coordinate space and symmetric with respect to the other axis of the coordinate space.

Particular aspects of the subject matter described in this disclosure can be implemented to realize one or more of the following potential advantages. In some examples, the described techniques can be used to map two or more bits associated with a channel code to a complex modulation symbol in a manner that balances protections on each bit such that no single bit dominates overall modulation performance. Accordingly, in some examples, the described techniques can improve modulation and decoding performance for a channel code when a receiver uses a sub-optimal decoder, such as a successive cancellation (list) decoder, which may reduce complexity and/or conserve resources at the receiver relative to an ideal or optimal decoder (for example, an ML decoder). For example, the described techniques may be used to design a constellation with an asymmetric or partially asymmetric shape such that, when a signal is uniformly distributed over the points forming the constellation, a resulting modulated symbol has a zero mean and a unit variance. In addition, the described techniques can be used to optimize one or more parameters that define the constellation shape according to a coding rate and/or the decoder in use at the receiver, which may improve performance in accordance with specific channel conditions (for example, a lower BER, a lower BLER, a distance spectrum with a more Gaussian distribution, and/or a higher SNR relative to BPSK and/or QPSK modulation techniques that map channel codes to constellations with a symmetric shape, such as a square or a circle).

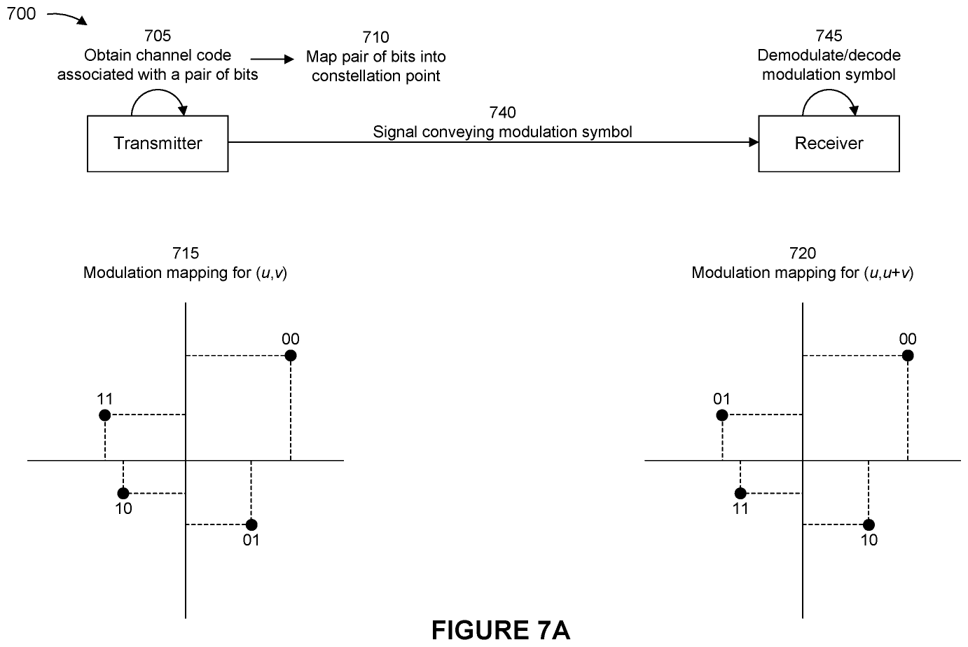

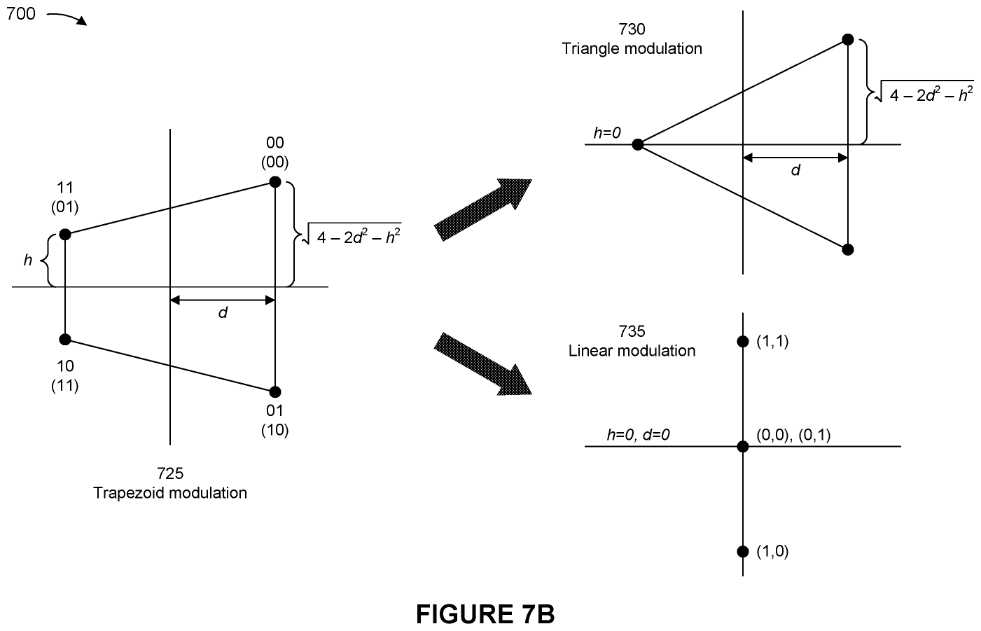

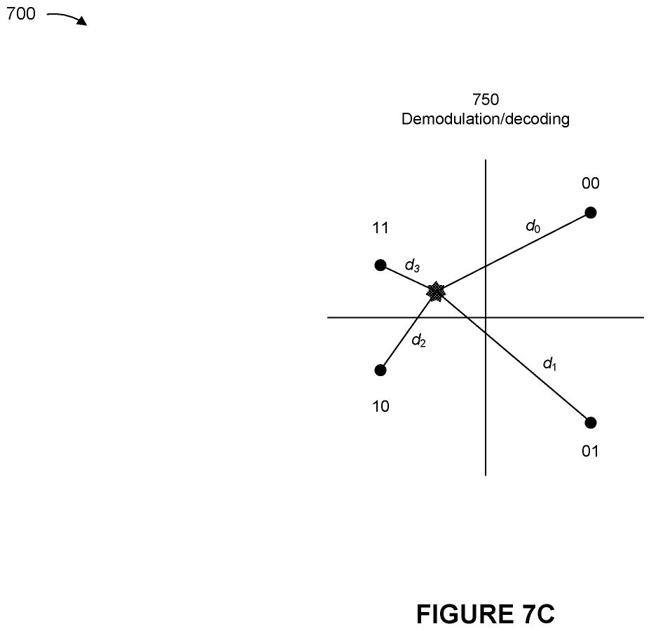

FIGS. 7A-7C are diagrams illustrating examples 700 associated with a modulation scheme for channel codes in accordance with the present disclosure. As shown in FIG. 7A, examples 700 includes communication between a transmitter and a receiver. For example, in some aspects, the transmitter may correspond to a UE 120, and the receiver may correspond to a network node 110, a second UE 120, and/or another suitable wireless device. Additionally or alternatively, the transmitter may correspond to a network node 110, and the receiver may correspond to a UE 120, a second network node 110, and/or another suitable wireless device. In some aspects, the transmitter and the receiver may be included in a wireless network, such as wireless network 100. The transmitter and the receiver may communicate via a wireless link, such as an access link that includes an uplink and a downlink, a sidelink, a wireless backhaul link, and/or another suitable wireless link.

As shown in FIG. 7A, in a first operation 705, the transmitter may obtain a channel code associated with a pair of bits. For example, in some aspects, the channel code may be a Reed-Muller code, a polar code, or another suitable code associated with a Plotkin construction or similar transform function. For example, as described herein, the transmitter may include an encoder that generates the channel code, where the encoder may be a Reed-Muller encoder, a polar encoder, or another suitable encoder that includes one or more Plotkin kernels that output the pair of bits, such that the pair of bits to be modulated or mapped is represented as (u, u+v). Additionally or alternatively, the encoder may be a modified Reed-Muller encoder, a modified polar encoder, or another suitable encoder that output the pair of bits prior to a Plotkin construction being applied, such that the pair of bits is represented as (u, v). As further shown in FIG. 7A, in a second operation 710, the transmitter may map the pair of bits into a point in a constellation in a coordinate space (for example, a real coordinate plane, R²). For example, as described herein, the constellation includes a plurality of points that each correspond to a complex modulation symbol representing a possible combination of values for the pair of bits to be mapped (for example, ‘00’, ‘01’, ‘10’, or ‘11’ in the case of a two-bit mapping). Accordingly, the coordinate space includes a first (for example, horizontal) axis representing an in-phase or real component of the complex modulation symbol and a second (for example, vertical) axis that is perpendicular to the first axis to represent a quadrature or imaginary component of the complex modulation symbol. In some aspects, as described the constellation may be designed such that each point is placed at an arbitrary position in the coordinate space, conditioned on there being non-uniform distances between adjacent points (for example, a distance between a first point corresponding to a ‘00’ bit combination and a second point corresponding to a ‘01’ bit combination is different from a distance between the second point corresponding to the ‘01’ bit combination and a third point corresponding to a ‘10’ bit combination). In other words, the constellation may have four points that are asymmetric with respect to at least one of the axes.

Furthermore, in some aspects, to avoid over-clustering the various points in the constellation, which may degrade modulation and/or demodulation/decoding performance, the constellation is designed such that one point is located in each quadrant of the coordinate space. In this way, the constellation may be biased toward asymmetry, which may provide improved performance relative to a square or other symmetric modulation (such as BPSK or QPSK) without loss of optimality. For example, the constellation may include a first point in an upper-right quadrant to represent a positive-positive mapping for the pair of bits, a second point in an upper-left quadrant to represent a negative-positive mapping for the pair of bits, a third point in a lower-left quadrant to represent a negative-negative mapping for the pair of bits, and a fourth point in a lower-right quadrant to represent a positive-negative mapping for the pair of bits. Accordingly, in some aspects, the transmitter may map the pair of bits in a manner that generalizes the Plotkin construction (u, v) [symbol] [(−1)^{u}, (−1)^{u+v}].

For example, FIG. 7A depicts a modulation mapping 715 that the transmitter may use to map the pair of bits, (u, v), before applying the Plotkin construction into the arbitrary points in the constellation. In such examples, the encoder may be configured to output the channel code in the form (u, v), and each point in the constellation has a bit labeling associated with the generalized Plotkin construction (for example, where (u, v)=(0,0) maps to the point in the upper-right quadrant with a positive x-coordinate and a positive y-coordinate, (u, v)=(0,1) maps to the point in the lower-right quadrant with a positive x-coordinate and a negative y-coordinate, (u, v)=(1,0) maps to the point in the lower-left quadrant with a negative x-coordinate and a negative y-coordinate, and (u, v)=(1,1) maps to the point in the upper-right quadrant with a negative x-coordinate and a positive y-coordinate). Alternatively, FIG. 7A depicts a modulation mapping 720 that may be used to map two bits, (u, u+v), that are output from the same Plotkin kernel (for example, in a typical Reed-Muller or polar encoder). In such examples, the encoder may be configured to output the channel code in the form (u, u+v), such that the transmitter jointly modulates u and u+v. In such examples, the constellation may have the same shape, but each point in the constellation has a bit labeling associated with the jointly modulated bits that are output from the same Plotkin kernel (for example, where (u, u+v)=(0,0) maps to the point in the upper-right quadrant with a positive x-coordinate and a positive y-coordinate, (u, u+v)=(0,1) maps to the point in the upper-left quadrant with a negative x-coordinate and a positive y-coordinate, (u, u+v)=(1,0) maps to the point in the lower-right quadrant with a positive x-coordinate and a negative y-coordinate, and (u, u+v)=(1,1) maps to the point in the lower-left quadrant with a negative x-coordinate and a negative y-coordinate). As shown in FIG. 7A, the only difference between modulating (u, v) versus jointly modulating (u, u+v) is the bit labelling associated with each point in the constellation.

As shown in FIG. 7B, the constellation may have other suitable shapes that may provide improved performance over a shape that is asymmetric with respect to both the horizontal and vertical axes. For example, in some aspects, the constellation may be associated with a mirror symmetry, where the constellation is symmetric with respect to a first axis and asymmetric with respect to a second axis, where the symmetric structure may provide a modulation design that improves performance over a shape that is asymmetric with respect to both the horizontal and vertical axes. For example, as shown in FIG. 7B, the constellation may provide a trapezoid modulation 725, which is symmetric with respect to the horizontal axis representing the in-phase or real component of the modulation symbol and asymmetric with respect to the vertical axis representing the quadrature or imaginary component of the modulation symbol. Alternatively, in some aspects, the trapezoid modulation 725 may be rotated 90 degrees in a clockwise or counter-clockwise direction such that the constellation which is symmetric with respect to the vertical axis representing the quadrature or imaginary component of the modulation symbol and symmetric with respect to the horizontal axis representing the in-phase or real component of the modulation symbol.

In some aspects, as shown in FIG. 7B, the trapezoidal constellation may be parameterized according to a first parameter, h, where h∈[0,2], and a second parameter, d, where d∈[0, \sqrt{2}]. For example, as shown, h represents the distance between the horizontal axis and the point in the upper-left quadrant and the distance between the horizontal axis and the point in the lower-left quadrant, d represents the distance between the vertical axis and each point in the constellation, with h and d having respective values that satisfy the constraint h²+2d²≤4 (for example, such that the other edge of the trapezoidal constellation has a non-negative length). Furthermore, a distance between the horizontal axis and the points in the upper-right and lower-right quadrants may be parameterized according to h and d (for example, \sqrt{4−2d²−h²}). Accordingly, in some aspects, the four points in the trapezoidal constellation may be located at (d, \sqrt{4−2d²−h²}), (d, −\sqrt{4−2d²−h²}), (−d, h), and (−d, −h). Furthermore, in FIG. 7B, the bit labeling in parentheses may correspond to a joint modulation of (u, u+v) (for example, after a Plotkin transform applied by a Reed-Muller encoder and/or a polar encoder), and the bit labeling without parentheses may correspond to a modulation of (u, v) (for example, where the two bits are mapped prior to the Plotkin construction). In some aspects, this parameterization for the trapezoid modulation 725 may satisfy a condition that, when a signal is uniformly distributed over the four modulation points, the resulting modulated symbol has a zero mean and a unit variance. Furthermore, optimal values for h and d may depend on the channel codes to be modulated (for example, depending on a coding rate and/or a decoder in use at the receiver). For example, the optimal values for h and d may be h=0.4 and d=1 for the Reed-Muller code RM(9, 2) and a successive cancellation decoder, and such values may differ for other combinations of Reed-Muller codes, polar codes, and/or decoders.

In some aspects, FIG. 7B further illustrates specific variants on the trapezoid modulation 725. For example, FIG. 7B illustrates a triangle modulation 730, which may provide a three-point modulation where h=0 (for example, the constellation includes one point that is on the horizontal axis, where such point may correspond to (u, u+v)=(0,1) or (u, u+v)=(1,1) when (u, u+v) is jointly modulated or to (u, v)=(1,1) or (u, v)=(1,0) when (u, v) is modulated). Additionally or alternatively, FIG. 7B illustrates a linear modulation 735, which may provide a three-point modulation where h=0 and d=0 (for example, the constellation includes three points that are on the vertical axis, including one point at the origin, where FIG. 7B depicts the bit labeling that may be applied to such points when (u, u+v) is jointly modulated. In general, as described herein, optimal values for h and d may vary in different circumstances, for example, to balance protections for u and v. For example, the linear modulation 735 may be used when a wireless channel is an additive white noise Gaussian noise binary erasure channel (AWGN-BEC) for v.

Accordingly, referring again to FIG. 7A, in a third operation 740, the transmitter may transmit, to the receiver via a wireless channel, a signal that conveys the complex modulation symbol mapped to the pair of bits. In a fourth operation 745, the receiver may then demodulate or decode the complex modulation symbol. For example, FIG. 7C illustrates an example demodulation/decoding 750 that may be applied at the receiver. For example, in FIG. 7C, the star represents the signal that is received at the receiver, and the receiver then computes distances from the received signal to each point in the constellation (shown as d₀, d₁, d₂, and d₃). Accordingly, the receiver may first demodulate/decode v using a log-map (or max-log-map) function associated with a log likelihood ratio (LLR), as follows:

$$L L R ( v ) = log \frac{{e}^{- {d}_{0}^{2}} + {e}^{- {d}_{2}^{2}}}{{e}^{- {d}_{1}^{2}} + {e}^{- {d}_{3}^{2}}}$$

In some aspects, the receiver may then make a hard decision on v, and may then demodulate/decode u according to the hard decision on v, as follows:

$$L L R ( u \vert v = \hat{v} ) = \{ \begin{matrix}{d}_{2}^{2} - {d}_{0}^{2} , & if \hat{v} = 0 \\ {d}_{3}^{2} - {d}_{1}^{2} , & if \hat{v} = 1\end{matrix}$$

FIG. 8 is a flowchart illustrating an example process 800 performed, for example, at a transmitter or an apparatus of a transmitter that supports wireless communication in accordance with the present disclosure. Example process 800 is an example where the apparatus or the transmitter (for example, UE 120 and/or network node 110) performs operations associated with a modulation scheme for channel codes.

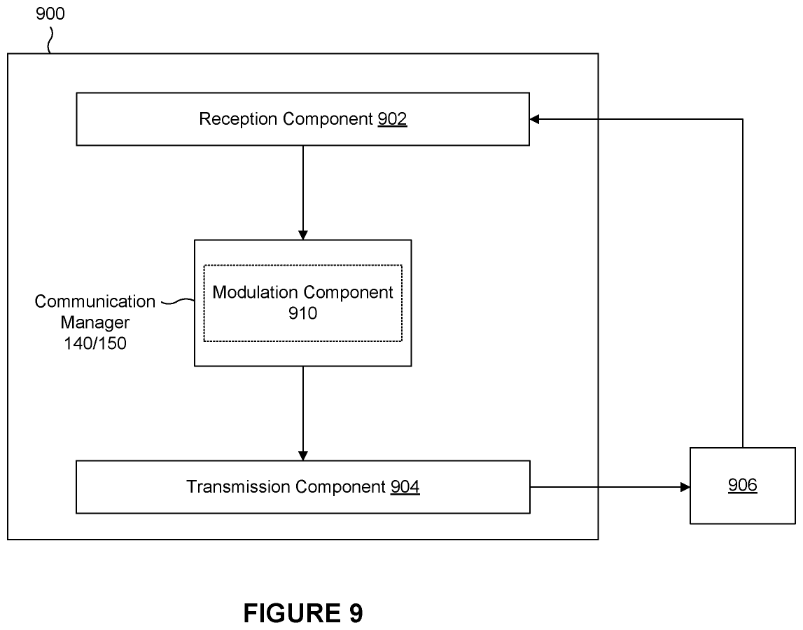

As shown in FIG. 8, in some aspects, process 800 may include mapping a pair of bits associated with a channel code to a modulation symbol that corresponds to a point in a constellation that includes a plurality of points, there being non-uniform distances between adjacent points of the plurality of points (block 810). For example, the transmitter (such as by using communication manager 140/150 or modulation component 910, depicted in FIG. 9) may map a pair of bits associated with a channel code to a modulation symbol that corresponds to a point in a constellation that includes a plurality of points, there being non-uniform distances between adjacent points of the plurality of points, as described above.

As further shown in FIG. 8, in some aspects, process 800 may include transmitting a signal that conveys the modulation symbol to a receiver (block 820). For example, the transmitter (such as by using communication manager 140/150 or transmission component 904, depicted in FIG. 9) may transmit a signal that conveys the modulation symbol to a receiver, as described above.

Process 800 may include additional aspects, such as any single aspect or any combination of aspects described below or in connection with one or more other processes described elsewhere herein.

In a first additional aspect, mapping the pair of bits comprises applying a transform function to the pair of bits, and each point of the plurality of points is associated with a respective label corresponding to a possible value for the pair of bits prior to the application of the transform function to the pair of bits.

In a second additional aspect, alone or in combination with the first aspect, mapping the pair of bits comprises applying a transform function to the pair of bits, and each point of the plurality of points is associated with a respective label corresponding to a possible value for the pair of bits after the application of the transform function to the pair of bits.

In a third additional aspect, alone or in combination with one or more of the first and second aspects, the constellation consists of one point in each quadrant of a coordinate space that includes a first axis representing an in-phase or real component of the modulation symbol and a second axis representing a quadrature or imaginary component of the modulation symbol.

In a fourth additional aspect, alone or in combination with one or more of the first through third aspects, the constellation is asymmetric with respect to a first axis representing an in-phase or real component of the modulation symbol and asymmetric with respect to a second axis representing a quadrature or imaginary component of the modulation symbol.

In a fifth additional aspect, alone or in combination with one or more of the first through fourth aspects, the constellation is symmetric with respect to a first axis representing a first component of the modulation symbol and asymmetric with respect to a second axis representing a second component of the modulation symbol.

In a sixth additional aspect, alone or in combination with one or more of the first through fifth aspects, the constellation has a trapezoidal shape.

In a seventh additional aspect, alone or in combination with one or more of the first through sixth aspects, the constellation consists of four points in a coordinate space, the four points being defined according to a first parameter with a first value that represents a first distance from a first axis of the coordinate space, a second parameter with a second value that represents a second distance from a second axis of the coordinate space, and a third parameter with a third value that represents a third distance from the first axis of the coordinate space in accordance with the first value and the second value.

In an eighth additional aspect, alone or in combination with one or more of the first through seventh aspects, one or both of the first value of the first parameter or the second value of the second parameter are related to one or both of a coding rate or a decoder associated with the receiver.

In a ninth additional aspect, alone or in combination with one or more of the first through eighth aspects, the first parameter has a zero value and the second parameter has a non-zero value.

In a tenth additional aspect, alone or in combination with one or more of the first through ninth aspects, the first parameter has a zero value and the second parameter has a zero value.

In an eleventh additional aspect, alone or in combination with one or more of the first through tenth aspects, the signal is uniformly distributed over the plurality of points in the constellation such that the modulated symbol has a zero mean and a unit variance.

In a twelfth additional aspect, alone or in combination with one or more of the first through eleventh aspects, the channel code is one or more of a Reed-Muller code, a polar code, or another code associated with a Plotkin construction.

Although FIG. 8 shows example blocks of process 800, in some aspects, process 800 may include additional blocks, fewer blocks, different blocks, or differently arranged blocks than those depicted in FIG. 8. Additionally or alternatively, two or more of the blocks of process 800 may be performed in parallel.

FIG. 9 is a diagram of an example apparatus 900 for wireless communication that supports a modulation scheme for channel codes in accordance with the present disclosure. The apparatus 900 may be a transmitter, or a transmitter may include the apparatus 900. In some aspects, the apparatus 900 includes a reception component 902, a transmission component 904, and a communication manager 140/150, which may be in communication with one another (for example, via one or more buses). As shown, the apparatus 900 may communicate with another apparatus 906 (such as a UE, a network node, or another wireless communication device) using the reception component 902 and the transmission component 904.

In some aspects, the apparatus 900 may be configured to and/or operable to perform one or more operations described herein in connection with FIGS. 7A-7C. Additionally or alternatively, the apparatus 900 may be configured to and/or operable to perform one or more processes described herein, such as process 800 of FIG. 8. In some aspects, the apparatus 900 may include one or more components of the UE 120 and/or the network node 110 described above in connection with FIG. 2.

The reception component 902 may receive communications, such as reference signals, control information, and/or data communications, from the apparatus 906. The reception component 902 may provide received communications to one or more other components of the apparatus 900, such as the communication manager 140/150. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 902 may include one or more antennas, one or more modems, one or more demodulators, one or more MIMO detectors, one or more receive processors, one or more controllers/processors, and/or one or more memories of the transmitter described above in connection with FIG. 2.

The transmission component 904 may transmit communications, such as reference signals, control information, and/or data communications, to the apparatus 906. In some aspects, the communication manager 140/150 may generate communications and may transmit the generated communications to the transmission component 904 for transmission to the apparatus 906. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 906. In some aspects, the transmission component 904 may include one or more antennas, one or more modems, one or more modulators, one or more transmit MIMO processors, one or more transmit processors, one or more controllers/processors, and/or one or more memories of the transmitter described above in connection with FIG. 2. In some aspects, the transmission component 904 may be co-located with the reception component 902 in one or more transceivers.

The communication manager 140/150 may map a pair of bits associated with a channel code to a modulation symbol that corresponds to a point in a constellation that includes a plurality of points, there being non-uniform distances between adjacent points of the plurality of points. The communication manager 140/150 may transmit or may cause the transmission component 904 to transmit a signal that conveys the modulation symbol to a receiver. In some aspects, the communication manager 140/150 may perform one or more operations described elsewhere herein as being performed by one or more components of the communication manager 140/150.

The communication manager 140/150 may include one or more controllers/processors, one or more memories, one or more schedulers, and/or one or more communication units of the network node 110 described above in connection with FIG. 2. Additionally or alternatively, the communication manager 140/150 may include one or more controllers/processors and one or more memories of the UE 120 described above in connection with FIG. 2. In some aspects, the communication manager 140/150 includes a set of components, such as a modulation component 910. Alternatively, the set of components may be separate and distinct from the communication manager 140/150. In some aspects, one or more components of the set of components may include or may be implemented within one or more controllers/processors, one or more memories, one or more schedulers, and/or one or more communication units of the network node 110 and/or one or more controllers/processors and/or one or more memories of the UE 120 described above in connection with FIG. 2. Additionally or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The modulation component 910 may map a pair of bits associated with a channel code to a modulation symbol that corresponds to a point in a constellation that includes a plurality of points, there being non-uniform distances between adjacent points of the plurality of points. The transmission component 904 may transmit a signal that conveys the modulation symbol to a receiver.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally or alternatively, a set of (one or more) components shown in FIG. 9 may perform one or more functions described as being performed by another set of components shown in FIG. 9.

The following provides an overview of some Aspects of the present disclosure:
Aspect 1: A method of wireless communication performed by a transmitter, comprising: mapping a pair of bits associated with a channel code to a modulation symbol that corresponds to a point in a constellation that includes a plurality of points, there being non-uniform distances between adjacent points of the plurality of points; and transmitting a signal that conveys the modulation symbol to a receiver.
Aspect 2: The method of Aspect 1, wherein mapping the pair of bits comprises applying a transform function to the pair of bits, and wherein each point of the plurality of points is associated with a respective label corresponding to a possible value for the pair of bits prior to the application of the transform function to the pair of bits.
Aspect 3: The method of Aspect 1, wherein mapping the pair of bits comprises applying a transform function to the pair of bits, and wherein each point of the plurality of points is associated with a respective label corresponding to a possible value for the pair of bits after the application of the transform function to the pair of bits.
Aspect 4: The method of any of Aspects 1-3, wherein the constellation consists of one point in each quadrant of a coordinate space that includes a first axis representing an in-phase or real component of the modulation symbol and a second axis representing a quadrature or imaginary component of the modulation symbol.
Aspect 5: The method of any of Aspects 1-4, wherein the constellation is asymmetric with respect to a first axis representing an in-phase or real component of the modulation symbol and asymmetric with respect to a second axis representing a quadrature or imaginary component of the modulation symbol.
Aspect 6: The method of any of Aspects 1-5, wherein the constellation is symmetric with respect to a first axis representing a first component of the modulation symbol and asymmetric with respect to a second axis representing a second component of the modulation symbol.
Aspect 7: The method of any of Aspects 1-6, wherein the constellation has a trapezoidal shape.
Aspect 8: The method of any of Aspects 1-7, wherein the constellation consists of four points in a coordinate space, the four points being defined according to a first parameter with a first value that represents a first distance from a first axis of the coordinate space, a second parameter with a second value that represents a second distance from a second axis of the coordinate space, and a third parameter with a third value that represents a third distance from the first axis of the coordinate space in accordance with the first value and the second value.
Aspect 9: The method of Aspect 8, wherein one or both of the first value of the first parameter or the second value of the second parameter are related to one or both of a coding rate or a decoder associated with the receiver.
Aspect 10: The method of Aspect 8, wherein the first parameter has a zero value and the second parameter has a non-zero value.
Aspect 11: The method of Aspect 8, wherein the first parameter has a zero value and the second parameter has a zero value.
Aspect 12: The method of any of Aspects 1-11, wherein the signal is uniformly distributed over the plurality of points in the constellation such that the modulated symbol has a zero mean and a unit variance.
Aspect 13: The method of any of Aspects 1-12, wherein the channel code is one or more of a Reed-Muller code, a polar code, or another code associated with a Plotkin construction.
Aspect 14: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-13.
Aspect 15: An apparatus for wireless communication at a device, the apparatus comprising one or more memories and one or more processors coupled to the one or more memories, the one or more processors configured to cause the device to perform the method of one or more of Aspects 1-13.
Aspect 16: An apparatus for wireless communication, the apparatus comprising at least one means for performing the method of one or more of Aspects 1-13.
Aspect 17: A non-transitory computer-readable medium storing code for wireless communication, the code comprising instructions executable by one or more processors to perform the method of one or more of Aspects 1-13.
Aspect 18: A non-transitory computer-readable medium storing a set of instructions for wireless communication, the set of instructions comprising one or more instructions that, when executed by one or more processors of a device, cause the device to perform the method of one or more of Aspects 1-13.
Aspect 19: A device for wireless communication, the device comprising a processing system that includes one or more processors and one or more memories coupled with the one or more processors, the processing system configured to cause the device to perform the method of one or more of Aspects 1-13.
Aspect 20: An apparatus for wireless communication at a device, the apparatus comprising one or more memories and one or more processors coupled to the one or more memories, the one or more processors individually or collectively configured to cause the device to perform the method of one or more of Aspects 1-13.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and at least one of software or firmware. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based on or otherwise in association with” unless explicitly stated otherwise. Also, as used herein, the term “or” is intended to be inclusive when used in a series and may be used interchangeably with “and/or,” unless explicitly stated otherwise (for example, if used in combination with “either” or “only one of”). It should be understood that “one or more” is equivalent to “at least one.”

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set.

What is claimed is:

1. A transmitter for wireless communication, comprising:
a processing system that includes one or more processors and one or more memories coupled with the one or more processors, the processing system configured to cause the transmitter to:
map a pair of bits associated with a channel code to a modulation symbol that corresponds to a point in a constellation that includes a plurality of points, there being non-uniform distances between adjacent points of the plurality of points; and
transmit a signal that conveys the modulation symbol to a receiver.

2. The transmitter of claim 1, wherein mapping the pair of bits comprises applying a transform function to the pair of bits, and wherein each point of the plurality of points is associated with a respective label corresponding to a possible value for the pair of bits prior to the application of the transform function to the pair of bits.

3. The transmitter of claim 1, wherein mapping the pair of bits comprises applying a transform function to the pair of bits, and wherein each point of the plurality of points is associated with a respective label corresponding to a possible value for the pair of bits after application of the transform function to the pair of bits.

4. The transmitter of claim 1, wherein the constellation consists of one point in each quadrant of a coordinate space that includes a first axis representing an in-phase or real component of the modulation symbol and a second axis representing a quadrature or imaginary component of the modulation symbol.

5. The transmitter of claim 1, wherein the constellation is asymmetric with respect to a first axis representing an in-phase or real component of the modulation symbol and asymmetric with respect to a second axis representing a quadrature or imaginary component of the modulation symbol.

6. The transmitter of claim 1, wherein the constellation is symmetric with respect to a first axis representing a first component of the modulation symbol and asymmetric with respect to a second axis representing a second component of the modulation symbol.

7. The transmitter of claim 1, wherein the constellation has a trapezoidal shape.

8. The transmitter of claim 1, wherein the constellation consists of four points in a coordinate space, the four points being defined according to a first parameter with a first value that represents a first distance from a first axis of the coordinate space, a second parameter with a second value that represents a second distance from a second axis of the coordinate space, and a third parameter with a third value that represents a third distance from the first axis of the coordinate space in accordance with the first value and the second value.

9. The transmitter of claim 8, wherein one or both of the first value of the first parameter or the second value of the second parameter are related to one or both of a coding rate or a decoder associated with the receiver.

10. The transmitter of claim 8, wherein the first parameter has a zero value and the second parameter has a non-zero value.

11. The transmitter of claim 8, wherein the first parameter has a zero value and the second parameter has a zero value.

12. The transmitter of claim 1, wherein the signal is uniformly distributed over the plurality of points in the constellation such that the modulated symbol has a zero mean and a unit variance.

13. The transmitter of claim 1, wherein the channel code is one or more of a Reed-Muller code, a polar code, or another code associated with a Plotkin construction.

14. A method of wireless communication performed by a transmitter, comprising:
mapping a pair of bits associated with a channel code to a modulation symbol that corresponds to a point in a constellation that includes a plurality of points, there being non-uniform distances between adjacent points of the plurality of points; and
transmitting a signal that conveys the modulation symbol to a receiver.

15. The method of claim 14, wherein mapping the pair of bits comprises applying a transform function to the pair of bits, and wherein each point of the plurality of points is associated with a respective label corresponding to a possible value for the pair of bits prior to the application of the transform function to the pair of bits.

16. The method of claim 14, wherein mapping the pair of bits comprises applying a transform function to the pair of bits, and wherein each point of the plurality of points is associated with a respective label corresponding to a possible value for the pair of bits after application of the transform function to the pair of bits.

17. The method of claim 14, wherein the constellation consists of one point in each quadrant of a coordinate space that includes a first axis representing an in-phase or real component of the modulation symbol and a second axis representing a quadrature or imaginary component of the modulation symbol.

18. The method of claim 14, wherein the constellation is asymmetric with respect to a first axis representing an in-phase or real component of the modulation symbol and asymmetric with respect to a second axis representing a quadrature or imaginary component of the modulation symbol.

19. The method of claim 14, wherein the constellation is symmetric with respect to a first axis representing a first component of the modulation symbol and asymmetric with respect to a second axis representing a second component of the modulation symbol.

20. The method of claim 14, wherein the constellation has a trapezoidal shape.

21. The method of claim 14, wherein the constellation consists of four points in a coordinate space, the four points being defined according to a first parameter with a first value that represents a first distance from a first axis of the coordinate space, a second parameter with a second value that represents a second distance from a second axis of the coordinate space, and a third parameter with a third value that represents a third distance from the first axis of the coordinate space in accordance with the first value and the second value.

22. The method of claim 21, wherein one or both of the first value of the first parameter or the second value of the second parameter are related to one or both of a coding rate or a decoder associated with the receiver.

23. The method of claim 21, wherein the first parameter has a zero value and the second parameter has a non-zero value.

24. The method of claim 21, wherein the first parameter has a zero value and the second parameter has a zero value.

25. The method of claim 14, wherein the signal is uniformly distributed over the plurality of points in the constellation such that the modulated symbol has a zero mean and a unit variance.

26. The method of claim 14, wherein the channel code is one or more of a Reed-Muller code, a polar code, or another code associated with a Plotkin construction.

27. A non-transitory computer-readable medium storing a set of instructions for wireless communication, the set of instructions comprising:
one or more instructions that, when executed by one or more processors of a transmitter, cause the transmitter to:
map a pair of bits associated with a channel code to a modulation symbol that corresponds to a point in a constellation that includes a plurality of points, there being non-uniform distances between adjacent points of the plurality of points; and
transmit a signal that conveys the modulation symbol to a receiver.

28. The non-transitory computer-readable medium of claim 27, wherein the channel code is one or more of a Reed-Muller code, a polar code, or a code associated with a Plotkin construction.

29. An apparatus for wireless communication, comprising:
means for mapping a pair of bits associated with a channel code to a modulation symbol that corresponds to a point in a constellation that includes a plurality of points, there being non-uniform distances between adjacent points of the plurality of points; and
means for transmitting a signal that conveys the modulation symbol to a receiver.

30. The apparatus of claim 29, wherein the channel code is one or more of a Reed-Muller code, a polar code, or a code associated with a Plotkin construction.
